(19) United States
(12) Patent Application Publication
(10) Pub. No.: US 2004/0015556 A1
(43) Pub. Date: Jan. 22, 2004

(54) Software-based process/issue management system

(76) Inventor: Renu Chopra, Chatsworth, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/434,404

(22) Filed: May 8, 2003

Related U.S. Application Data
(60) Provisional application No. 60/379,288, filed on May 10, 2002.

(51) Int. Cl. G06F 15/16; G06F 12/00

(52) U.S. Cl. 709/206; 707/200

(57) ABSTRACT

An issue management system for tracking and monitoring issues across an organization includes a database suitable for storing multiple issues, where each issue pertains to a project and is to be resolved by an issue team having at least one member. The issues may, for example, be tracked and/or monitored in a standardized manner. The database can be dynamically updated in response to a first e-mail sent by said at least one member of the issue team. The issue management system can also automatically send a second e-mail to said at least one member of the issue team. The issues and their resolutions are automatically stored in the database, and the issues can be-consolidated at an enterprise level across the organization.

### CROSS-REFERENCE TO RELATED APPLICATION(S)

This application claims the benefit of U.S. Provisional Application No. 60/379,288 entitled “Software-Based Process/Issue Management System” filed May 10, 2002, the contents of which are fully incorporated by reference herein.

### FIELD OF THE INVENTION

The present invention relates generally to a software-based process/issue management system, and more particularly to a system that helps to better manage the business process, improve communication, increase efficiency and speed up the resolution of project issues.

### BACKGROUND

Issues or events that occur during projects may cost valuable time and money. Often, critical issues may not receive the visibility they need in a large organization and its impact can be widespread. Further, many issues occur repeatedly in various different parts of an enterprise. As projects are put on hold and restarted, or as project team members are changed, valuable time may be lost in identifying and dealing with issues that may previously have been encountered and resolved within the same or other projects within the enterprise.

The conditions in an organization that engender this type of atmosphere may include one or more of the following: 1) lack of company standardization in its methods used for documenting and resolving issues; 2) lack of time on the part of the issue leader or the project manager to inform any other members of the company who may be impacted by the issue or its resolution; and 3) lack of a system to consolidate types of key issues from across the organization for enterprise level visibility.

These conditions worsen within the context of a large program where several projects are inter-linked and a hierarchy of projects and sub-projects may exist. In this situation, using a standardized method for issue documentation, timely communication, and enterprise level reporting may result in many benefits.

Therefore, it is desirable to provide an enterprise level issue management system that can promote standardized issue identification, tracking and resolution across an organization.

### SUMMARY

In an exemplary embodiment according to the present invention, an issue management system for tracking and monitoring issues across an organization is provided. The issue management system comprises: a database suitable for storing a plurality of issues, each issue pertaining to a project and to be resolved by an issue team having at least one member; a database updater for dynamically updating the database in response to a first e-mail sent by said at least one member of the issue team; and an e-mail sender for automatically sending a second e-mail to said at least one member of the issue team, wherein the issues and their resolutions are automatically stored in the database, and wherein the issues can be consolidated at an enterprise level across the organization.

In another exemplary embodiment according to the present invention, a method of managing issues across an organization is provided. The method comprises: creating an issue to be resolved by an issue team having at least one member, said issue pertaining to a project; sending an e-mail containing the issue to the database, wherein the database is automatically updated to store the issue; automatically sending an e-mail to said at least one member of the issue team to notify or alert said at least one member; resolving the issue; and sending an e-mail containing a resolution of the issue to the database, wherein the database is automatically updated to store the resolution, wherein the issue can be consolidated with other issues at an enterprise level across the organization.

In yet another exemplary embodiment according to the present invention, a project management system is provided. The project management system comprises: an issue management component for tracking and resolving issues in a standardized manner across an organization, the issue management component comprising: a database suitable for storing a plurality of issues, each issue pertaining to a project and to be resolved by an issue team having at least one member; a database updater capable of dynamically updating the database in response to a first e-mail sent by said at least one member of the issue team; and an e-mail sender capable of automatically sending a second e-mail to said at least one member of the issue team, wherein the issues and their resolutions are automatically stored in the database, and wherein the issues can be consolidated at an enterprise level across the organization; and a project management component that has been integrated with the issue management component.

### BRIEF DESCRIPTION OF THE DRAWINGS

These and other aspects of the invention may be understood by reference to the following detailed description, taken in conjunction with the accompanying drawings, wherein:

FIG. 1 illustrates a software-based issue/project management system in an exemplary embodiment according to the present invention;

FIG. 2 is a flow diagram that illustrates a process of updating database and automatically generating e-mail in an exemplary embodiment according to the present invention;

FIG. 3 is a flow diagram that illustrates a process of creating organization and divisions, and adding of users;

FIG. 4 is a screen shot of a new organization screen in an exemplary embodiment according to the present invention;

FIG. 5 is a screen shot of an organization maintenance screen in an exemplary embodiment according to the present invention;

FIG. 6 is a screen shot of a new division screen in an exemplary embodiment according to the present invention;

FIG. 7 is a screen shot of a division maintenance screen in an exemplary embodiment according to the present invention;

FIG. 8 is a screen shot of a new user screen in an exemplary embodiment according to the present invention;

FIG. 9 is screen shot of a user maintenance screen in an exemplary embodiment according to the present invention;

FIG. 10 is a screen shot of a system settings screen in an exemplary embodiment according to the present invention;

FIG. 11 is a screen shot of an issue types screen in an exemplary embodiment according to the present invention;

FIG. 12 is a screen shot of a group type screen in an exemplary embodiment according to the present invention;

FIG. 13 is a screen shot of a history search screen in an exemplary embodiment according to the present invention;

FIG. 14 is screen shot of a history view screen in an exemplary embodiment according to the present invention;

FIG. 15 is a flow diagram that illustrates a process of creating projects in an exemplary embodiment according to the present invention;

FIG. 16 is a screen shot of a new project screen in an exemplary embodiment according to the present invention;

FIG. 17 is a screen shot of an attachments screen in an exemplary embodiment according to the present invention;

FIG. 18 is a screen shot of a project team screen in an exemplary embodiment according to the present invention;

FIG. 19 is a screen shot of a project level issue approvers screen in an exemplary embodiment according to the present invention;

FIG. 20 is a screen shot of a project level resolution approvers screen in an exemplary embodiment according to the present invention;

FIG. 21 is a screen shot of a project maintenance screen in an exemplary embodiment according to the present invention;

FIG. 22 is a screen shot of a sub-project screen in an exemplary embodiment according to the present invention;

FIG. 23 is a screen shot of a shift project screen in an exemplary embodiment according to the present invention;

FIG. 24 is a flow diagram that illustrates a process of creating issues in an exemplary embodiment according to the present invention;

FIG. 25 is a screen shot of a new issue screen in an exemplary embodiment according to the present invention;

FIG. 26 is a screen shot of an action/attachment screen in an exemplary embodiment according to the present invention;

FIG. 27 is a screen shot of an issue team screen in an exemplary embodiment according to the present invention;

FIG. 28 is a screen shot of an issue level approvers screen in an exemplary embodiment according to the present invention;

FIG. 29 is a screen shot of an issue maintenance screen in an exemplary embodiment according to the present invention;

FIG. 30 is a flow diagram that illustrates a process of resolving an issue in an exemplary embodiment according to the present invention;

FIG. 31 is a screen shot of a send e-mails screen in an exemplary embodiment according to the present invention;

FIG. 32 is a screen shot of a field selection screen in an exemplary embodiment according to the present invention;

FIG. 33 is a screen shot of a quick add defaults screen in an exemplary embodiment according to the present invention;

FIG. 34 is a screen shot of a quick add screen in an exemplary embodiment according to the present invention;

FIG. 35 is a screen shot of an inbox screen in an exemplary embodiment according to the present invention;

FIG. 36 is a screen shot of comments screen in an exemplary embodiment according to the present invention;

FIG. 37 is a screen shot of a my project screen in an exemplary embodiment according to the present invention;

FIG. 38 is a screen shot of a my issue screen in an exemplary embodiment according to the present invention;

FIG. 39 is a screen shot of a keyword search screen in an exemplary embodiment according to the present invention;

FIG. 40 is a screen shot of a project search criteria screen in an exemplary embodiment according to the present invention;

FIG. 41 is a screen shot of a project search result screen in an exemplary embodiment according to the present invention;

FIG. 42 is a screen shot of an issue search criteria screen in an exemplary embodiment according to the present invention;

FIG. 43 is a screen shot of an issue search result screen in an exemplary embodiment according to the present invention;

FIG. 44 is a screen shot of a date search screen in an exemplary embodiment according to the present invention;

FIG. 45 is a screen shot of an advanced issue search criteria screen in an exemplary embodiment according to the present invention;

FIG. 46 is a screen shot of an issue sort criteria screen in an exemplary embodiment according to the present invention;

FIG. 47 is a screen shot of an ad-hoc report screen in an exemplary embodiment according to the present invention;

FIG. 48 is a screen shot of a project-issue list screen in an exemplary embodiment according to the present invention;

FIG. 49 is a screen shot of a project-issue list screen in an exemplary embodiment according to the present invention;

FIG. 50 is a screen shot of a project-issue summary screen in an exemplary embodiment according to the present invention;

FIG. 51 is a screen shot of a project-issue summary screen in an exemplary embodiment according to the present invention;

FIG. 52 is a screen shot of an overdue report screen in an exemplary embodiment according to the present invention;

FIG. 53 is a screen shot of a detail due report screen in an exemplary embodiment according to the present invention;

FIG. 54 is a screen shot of a history screen in an exemplary embodiment according to the present invention;

FIG. 55 is a screen shot of history report screen in an exemplary embodiment according to the present invention;

FIG. 56 is a block diagram of a project management system that includes an issue management component and a project management component in an exemplary embodiment according to the present invention; and

FIG. 57 is a block diagram of a project management system that includes an issue management component and a project management component in another exemplary embodiment according to the present invention.

### DETAILED DESCRIPTION

In an exemplary embodiment according to the present invention, the steps involved in resolving and minimizing the negative impact of the issues within an organization may include one or more of the following: 1) provide a system to track and monitor a process or an issue in a standardized manner across the organization; 2) provide a system to build the documentation of the issue and its resolution over time; 3) provide a system to report on issues in a meaningful manner; and 4) provide a system to consolidate issues at the enterprise level so that an organization can realize the pervasiveness of a problem. Here, an organization may be a company (or a corporation), a division of a company, a department, a subsidiary, or the like, and the enterprise level may refer to “across the organization”.

Some of the features that may be provided in exemplary embodiments may include one or more of: 1) company standardization; 2) project level detail documentation; 3) enterprise level reporting; 4) issue approvals; 5) ability to keep the project and its issues private; 6) project hierarchy with sub-projects; 7) user authorizations/security; 8) reporting by department, project, issue leader, issue type and issue status; 9) e-mail ability; and 10) scalability

The issue management system of the present invention may be used as a tool for managers at any level of the organization. Within an information technology (IT) environment, the issue management system may allow for easy and quick documentation of issues that are encountered during any phase of a project and may provide the ability to manage the issue through its resolution. In the operations side of the business, the issue management system may allow a user to monitor and control the process, manage and improve team communication and provide documentation along the way.

In an exemplary embodiment, the issue management system of the present invention may encompass a process/issue management system that: 1) helps in capturing, filing and resolving all the issues pertaining to a project; 2) provides cross project, cross organization enterprise level information, with fluid documentation and workflow for effective communication about issues; 3) provides for issue approvals before making it publicly available, with automated alerts for approvals and resolutions; 4) can absorb an extensive hierarchy level with advanced security features; 5) provides powerful on-line reporting features at an enterprise level; and/or 6) has scope for unlimited organizations, divisions, users, projects/sub-projects and inter-project impacts.

The issue management system of the present invention encompasses a process/issue management software suitable to be a tool for the manager of any type of process or project in any industry. The issue management system is suitable for allowing easy and quick documentation of issues that are encountered during any phase of any type of project, and to provide the ability to manage the issue through its resolution. In one embodiment, the issue management system is an easy to use Internet/Intranet (i.e., web-based) application that is equally effective for the single user and is structured to be intuitive and friendly. The issue management system may help the organization to manage the resolution of problems, and may assist in eliminating barriers from the communication process, thus providing rapid problem resolution. An issue may be related to projects, represent the elements of a case, and/or purchase orders related to a store.

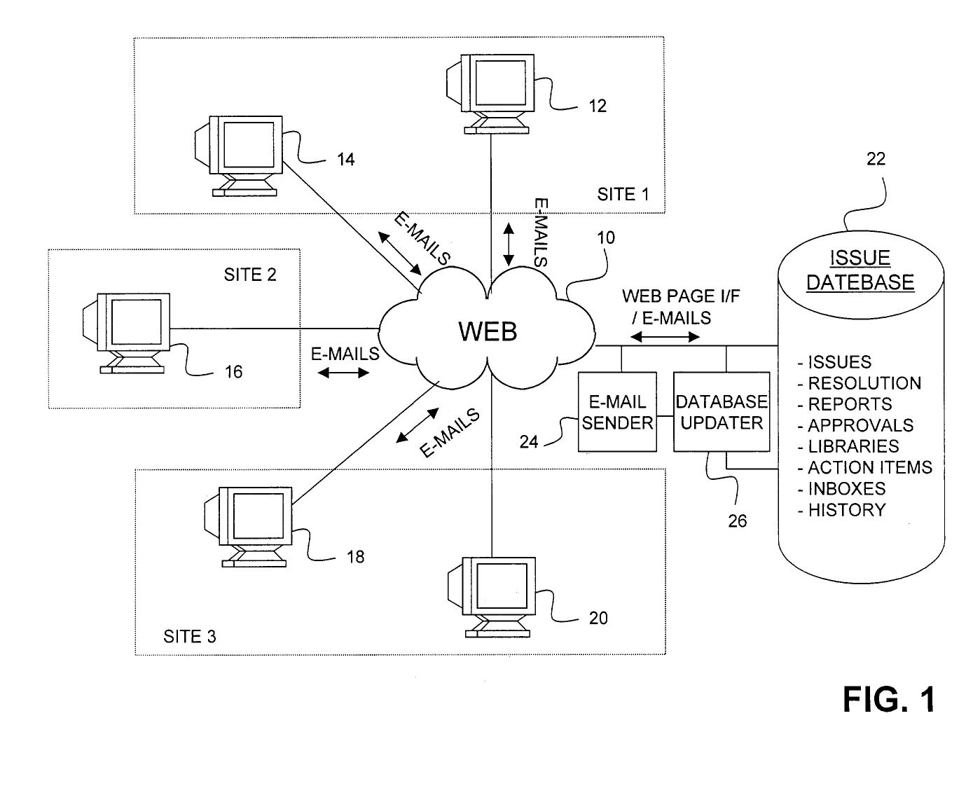

FIG. 1 illustrates a software-based issue/project management system (or issue management system) in an exemplary embodiment according to the present invention. The issue management system communicates over a web 10, and includes an issue database 22, which contains information pertinent to identifying and resolving issues such as issues, resolution, reports, approvals, libraries, actions items, inboxes, etc. The issue management system also includes an e-mail sender 24 and a database updater 26.

The issue team members (and/or other authorized personnel) who may be at multiple different locations, for example, 12 and 14 at site 1, 16 at site 2 and 18 and 20 at site 3, may access the information in the issue database 22 over the web 10 on-line using web browsers and an e-mail system. The e-mail sender 24 should be capable of automatically sending an e-mail to at least one member of the issue team. Such automatic sending of e-mails may be triggered by update to the database. The database updater 26 should be capable of dynamically updating the database in response to an e-mail sent by a member of the issue team.

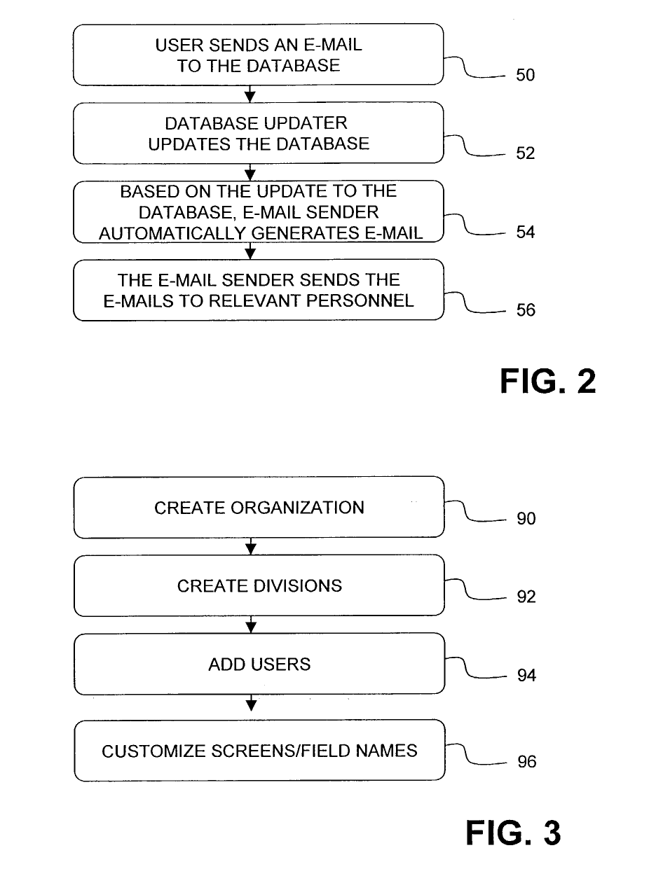

FIG. 2 is a flow diagram that illustrates a process of updating database and automatically generating e-mail in an exemplary embodiment according to the present invention. In Step 50, a user at one of the sites 1, 2 and 3 sends an e-mail to the issue database 22. The e-mails may also be automatically generated at one of the sites 1, 2 and 3. In step 52, the database updater 26 reads the e-mail, and updates the database 22 with the information contained therein. The e-mail may also be stored in the inboxes in the database 22 of the intended recipients. The information in the e-mails may include one or more of, but not limited to, issue/team member names, action items, rejections/approvals, attachments, new projects/issues, planned action resolution due dates, and the like. In other embodiments, the issue database 22 may be updated, for example, through a web page interface (e.g., using HTML) at the sites 1, 2 and/or 3.

Based on the update to the database 22, the e-mail sender 24 in step 54 automatically sends e-mails to those that are affected by such update. For example, when new issue team members are added to an issue, the e-mail sender 24 in step 56 should send an e-mail to each of the new and/or existing issue team members to alert them of the change to the issue team membership. In other embodiments, the e-mail sender and/or the database updater may be a man-in-the-loop system where human involvement is required or optional to update the database 22 and/or generate and send e-mails.

The issue management system of the present system may have one or more of the following functions and features.

The issue management system may have enterprise level capabilities with powerful -features for project managers and executives, for example, at one of the locations 12, 14, 16, 18 or 20. A “hierarchy” feature may provide for a capability to divide projects into sub-projects and relate issues to all levels. On-line reports may be provided to managers anywhere in the hierarchy, thus allowing for efficient streamlining of issue resolution.

An “approvals” feature may provide for a capability to require approvals for an issue before it is available for public viewing. In the same manner, a manager may decide to require approvals for the documented resolution before the issue can be considered resolved. These features may be available at the discretion of the project manager. Approvals may be required for all issues of the project, or decided upon on an issue-by-issue basis. An issue leader may even choose to approve the issue first before the other approvers.

An issue leader may solicit advice from other members of the organization using an “advisors” feature. In this case, the leader is not looking for approval, but is seeking their point of view.

An “enterprise level reporting” feature may allow searches for similar issues across projects and the entire organization through the use of “Issue Types” (or issue classifications) and key word searches, where the key words may be user-defined. This is a powerful on-line reporting feature that accumulates issues across organizations, divisions and projects. Visibility may specifically be provided to those issues that are similar, and/or are being addressed by various groups within the same organization. With this feature, the present invention may bring together all common issues relating to a particular subject for resolution at an enterprise level. This means that all issues pertaining to a particular element may be printed on a single report.

A “public/private view” feature may allow a project manager to decide whether the issues documented for a project will be available for public viewing. This provides executive management the ability to be discreet, while at the same time allowing them the use of an enterprise level tool that clearly and exhaustively documents any of their project issues. Restricting the project or issue to a private view still allows the project/issue team to work together.

An “authorized users/security” feature may allow for various levels of security built-in to the processing of the issue management system. Password security at the system level provides overall restricted access to users of the issue management system. Further, project managers and issue leaders may authorize users who are able to modify them. In an exemplary embodiment, only these authorized users or teams have the ability to add, maintain and delete project and issue information. This feature may also be used to limit the access of secure table information to administrators.

A “dashboard” feature may provide a bird's eye view of an organization. At a glance, users may know the number of issues created, resolved, due and overdue across the enterprise or in their project. They can select to keep the top projects or issues that they want to keep in touch with in the dashboard.

With “action items” features, users may assign tasks to team members within an issue team. These are tasks that should be completed in order to resolve the issue. These tasks may appear in the inbox of the person they are assigned to and they may also be notified through e-mail. The tasks may also appear in the assigned person's dashboard, which is an applications inbox.

A “project library” feature may allow a user to create a library. Documents may be attached to the project for reference by the team. Attachments may be made and stored at the project level. If documents are relevant to a specific issue, they may also be attached at the issue level.

The issue management system may also have a scalability feature. With the scalability feature, the issue management system of the present invention may be suitable to meet the business requirements of various sized companies. The software may be used in a small, one-project company on a single user system, as well as in an international multi-project, multi-division organization.

The hierarchical structure may leave flexibility in the organization of the information entirely in the hands of the user. The software typically puts no limits on the number of levels in the project/sub-project tree. Nor is there typically a limit in the number of divisions and organizations within the design. Whether single user, multi-user, or web-enabled, the issue management system should be easy to use, user friendly, intuitive in the screen design, and powerful in its capability.

A “team concept” may allow the issue management system of the present invention to work on the concept of project teams and issue teams. Because it is web-based, teams can be in multiple locations, internationally. Even when multiple locations are involved, team security may still be applied. This may allow the user to have control of issues over projects across the organization, across the nation, across international borders. For example, the sites 1, 2 and 3 of FIG. 1 may be located in different localities, countries and/or continents.

With an “intra-project and inter-project communication/e-mail enabled” feature, the issue management system may increase the level and quality of communication within a project and even outside the project or organization. The issue management system may be configured so that e-mails may be sent out automatically with the pertinent issue information to anyone that has an e-mail address. This feature may save the issue leader time that would have been used to develop an e-mail or to make the phone call. Once the issue has been entered within the issue management system, the same information may be sent to the person of user's choice. This feature is beyond simple notifications. E-mails may be used as an integral part of the issue management process. Each morning the issue leaders may receive in their inbox a report of their “TO Do” list.

An “ad hoc reporting” feature may provide users with an ability to create reports with the column heading of their choice. In essence, they may be able to create their own reports.

With a “financial value” feature, users may quantify the impact of an issue in financial terms. Once quantified, the user may perform searches based on cost.

Using a “customizable” feature, users may customize their own screens easily. They may select which fields they want to see for each issue or project screen. Users may determine whether they want the fields to be mandatory or optional.

A “reporting” feature may allow for queries by various elements of the issues, including the generation of status reports.

The following is a list of roles and responsibilities of different individuals using the issue/project management system in an exemplary embodiment according to the present invention.

The creator of the project may assign someone else to be the project manager or assign herself as the project manager. The creator has an authority to modify the project screens. However, she may only be able to create an issue if she is a member of the issue team. Both the creator and manager may be defaulted to be a member of the project team. The creator, however, may be removed from this team if she does not have open issues under her. Once the creator has been removed from the issue team, she no longer should have the authority to create issues for this project.

The creator of the issue should be a member of the project team. The issue creator may assign herself as the issue team leader or assign someone else as the issue team leader. The issue creator has the authority to modify this issue and may automatically be added as a member of the issue team. She may be removed from the team, however, by the issue leader. Once removed from the team, the issue creator may no longer modify this issue. The issue creator may reopen resolved and rejected issues.

The project manager may be assigned by the project creator and may be the same person. Once assigned, the project manager may be replaced if there are no open issues assigned to her name. The project manager should be removed only if another selection for this position is made at the same time. The project manager should have the right to modify the project screens and may automatically be added as a team member. The project manager should have the authority to create issues and grant override authority.

The issue team leader (or issue leader) may be assigned by the issue creator and may be the same person. The issue leader should already be a member of the project team prior to this assignment. The issue team leader should be removed from this role only if she is replaced by another member of the team. This replacement may be done by the issue team leader. The issue team leader should have the authority to modify the issue and may automatically be added to the issue team. The issue team leader may reopen resolved and rejected issues.

The administrator may have a very special role within the exemplary system of the present invention. The administrator may have the authority to create organizations, divisions, and users. The administrator may also have the authority to modify the name of the company found on the upper left hand side of the screen, as well as the ability to customize other aspects of the screens. The administrator may be any user and may often be simply a member of the project team. In addition, the administrator may add herself to the user list and thereby access the project and issue screens.

The vendor is an outside user who may have access to very limited functionalities within the system. The vendor may only view those reports and issues to which they have been assigned as a team member.

The user is anyone who is assigned a User Id within the system. The user may view projects and issue information on the system. Modification rights may be granted when the user is assigned as issue team leader, manager, or has an assignment as a team member of any project or issue. The user may select and see the reports in any way she wishes as long as the project or issue has not been defined as “Private.” The user may be deleted only if she is not a member of any team and is also not an approver. The user also may not be a project or issue creator in order to be deleted. The user may, however, be designated as inactive if they are found to have been a creator at anytime but does not have any association in a project or issue team.

The types of users in an exemplary embodiment according to the present invention may include the following three types. A “User” adds projects and issues. This is the normal user who is allowed to create projects. A “Super User (Modify)” may be the most powerful user in the system and should be reserved for management personnel. All projects and issues may be visible to this super user. This user may further have the ability to modify data regardless of whether he/she is on the team. A “Super User (View)” may have the capability to view all the projects and issue on the system regardless of whether she is on the team. Each of these users may be authorized to have administrative access. This allows the users to add and modify the administrative areas.

The role of an approver for the issue description or the issue resolution may be assigned by the project manager, project creator, issue leader, and/or issue creator. Upon sign-on, the approver may first see the approval screens to accept or reject the issues that have been routed to her. The approver may have an opportunity to send comments to the issue team leader along with an acceptance or rejection of the issue (issue description or issue resolution).

The approver may be added by the project creator or manager upon the creation of the project. At that time, the approver may be designated as “mandatory” or “optional”. All issues created for this project should carry the mandatory approver. The optional approver may only have issues routed if selected by the issue leader or creator.

Advisors are users who are not on the project team and are not approvers. However, the issue team may solicit opinion of the advisors on the issue. The advisor's role is to provide feedback on the issue without impacting the development cycle of the issue.

Once the issue management system has been installed, the following steps may be followed as a guide to get started with an exemplary embodiment. First, one or %more persons may be assigned to be the administrator of the issue management system. This person(s) will have access to functions that other users will not. The administrator(s) should first complete the following as illustrated on FIG. 3:

First in step 90, the administrator should create one or more organizations, which is the highest level of the hierarchy within an organization. Then in step 92, the administrator should create division(s), which is the second level in the hierarchy within an organization. One or more divisions may be created within each organization. The administrator should also add the users on the system in step 94. These users may create issues and projects. The administrator may also customize screens in step 96 for the company name, e-mail triggers, etc. In step 96, the administrator may also customize certain field names, and may view the history of modifications made to the organization, division and users. The administrator may also change and delete issue types and issue groups. The administrator may be able to decide whether these will be fixed or whether users may add a new issue type and/or issue group while creating an issue.

After initial set up by the administrator, the user may create issues and projects. Multiple projects may be created under one division, and the projects may be created with or without approvers, with sub-projects, and/or with a specified project team.

Once the projects are set up, the project team may create issues. The issues may be created using the new issue screens that may lead a user through the add process. Alternatively, issues may be created using quick add screens that allow for quick entry of issues. The quick add screens may be used to add many issues, for example, at the beginning of a project. A user may view her inbox, projects and issues, search keywords, project-issue reports, summary and detailed due reports and view the history of modifications, based on her specified criteria.

After setting up the issue management system, the administrator(s) and users may access the system by typing in a password. As is known to those skilled in the art, the password may be initially selected and/or modified. Further, the system may also provide for an occasion when a user forgets her password.

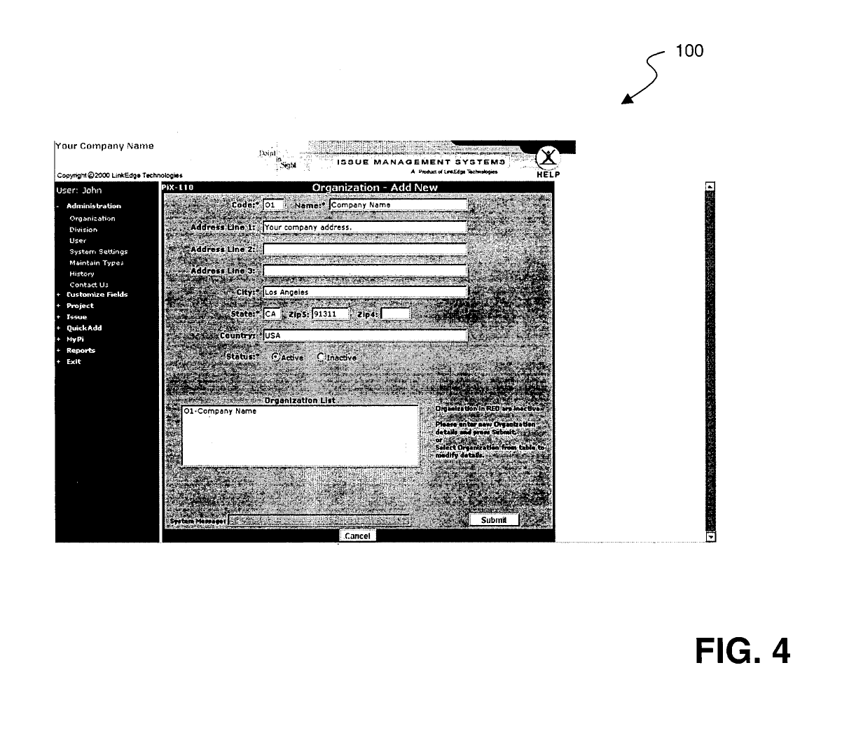

In the exemplary embodiment, only the administrator may create an organization. In other embodiments, users as well as the administrator may create an organization. For example, the organizations may be created using a new organization screen 100 of FIG. 4. An organization code entered in a “Code” field may be a two digit alphanumeric code used to designate the organization. The number of digits in the organization code may be different in other embodiments.

The company (or organization) name that corresponds to the organization code should be entered in the “Name” field. The organization's address should be entered in the “Address Lines 1-3”, “City”, “State”, “Zip 5, 4” and “Country” fields. Further, the status of the organization should be entered in the “Status” field, which may be either “active” or “inactive.” The “active” status may mean that the organization is in use and has data associated with it, and the “inactive” status may mean that this organization has not started using the issue management system. Further, the status of the organization may be selected to be “delete” to indicate that the organization should be deleted.

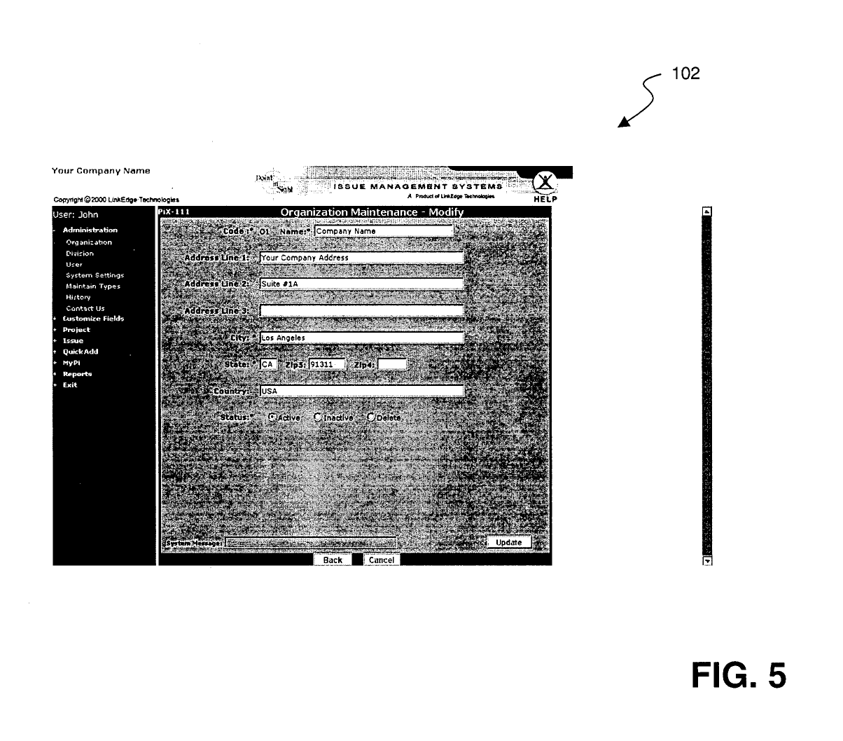

The details of the organization may be updated by selecting the organization in a table, such as the Organization List table of the new organization screen 100 of FIG. 4, to bring up an organization maintenance screen 102 of FIG. 5. A user may make desired modifications on the organization maintenance screen 102, and then click an “Update” button to modify the details of the organization.

In an exemplary embodiment according to the present invention, a division is the second highest level in the hierarchy of the issue management system. Many divisions may exist within a single organization. Divisions may represent geographic locations, profit centers or separate business types. They may be predefined or defined entirely by the user.

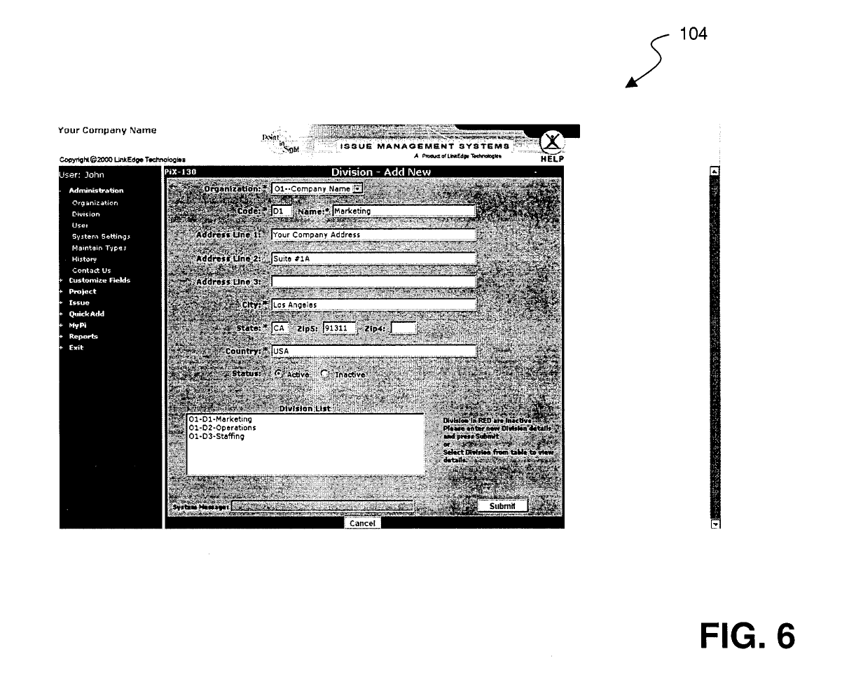

After creating an organization, a “Division” link on the left window frame may be clicked to reach a new division screen 104 of FIG. 6. Here, an organization from the drop-down menu may be selected for which a division is to be created. Then a two digit alphanumeric division code that will represent the new division may be entered in the “Code” field. In other embodiments, the number of digits in the division code may be different from two.

In the “Name” field, the name of the division corresponding to the division code should be entered. The organization's complete address may already have been entered by default. However, the address may be modified for the division by simply changing the information. Then the status of the division may be entered as either “active” or “inactive.” The “active” status may mean that the division is in use and has data associated with it, while the “inactive status” may mean that this division has not started using the issue management system.

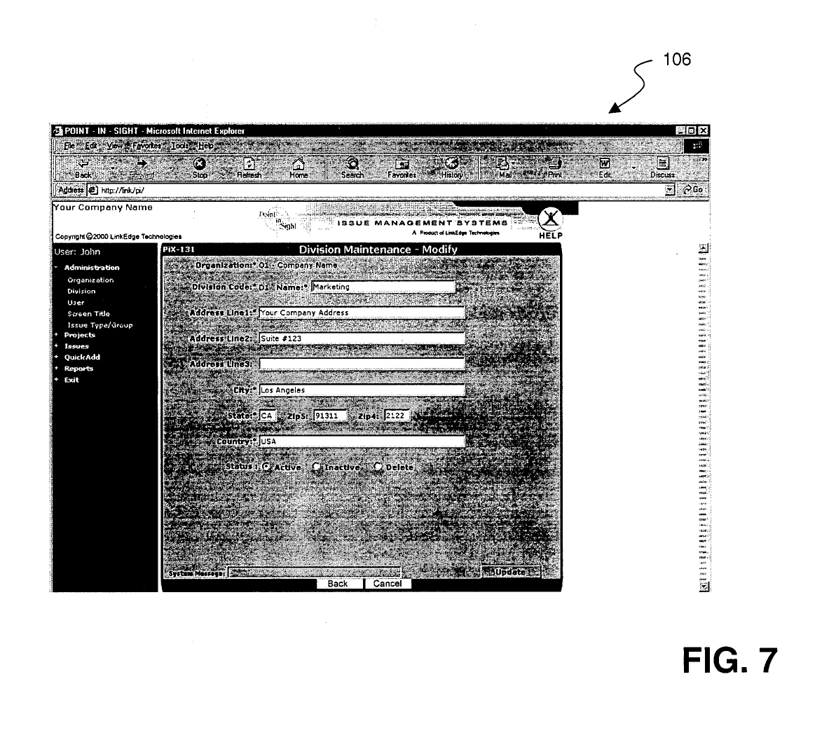

The details of the division may be modified by clicking on an appropriate division in the table, such as the Division List table in the new division screen 104 of FIG. 6, to bring up a division maintenance screen 106 of FIG. 7. The details of the selected division may be modified by making changes in the division maintenance screen 106, and then clicking the “Update” button.

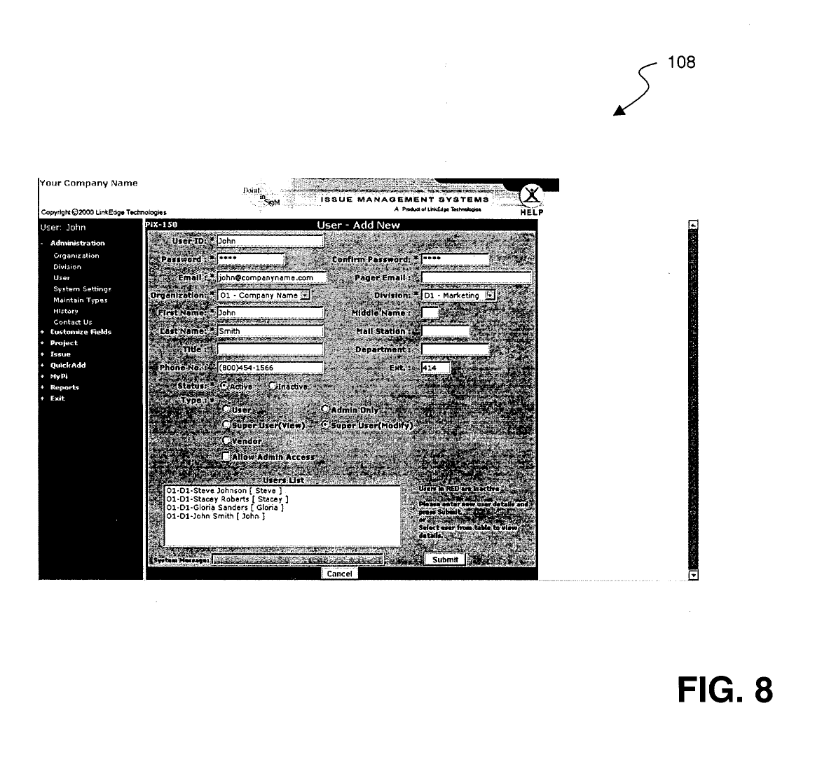

In the exemplary embodiment, users created by the administrator may use the issue management system. Users may be created by first clicking on the “User” link on the left window frame to bring up a new user screen 108 of FIG. 8, for example. The user creation may require entering one or more of the following information: 1) User ID; 2) Password; 3) E-mail address(es) 4) relevant organization and division from the drop-down menus that the new user belongs to begin to create the user list; 5) Name; 6) Mail Station; 7) Title; 8) Department; 9) Phone Number; 10) Extension; 11) Status; 12) Type (Choose the type of user, which may be marked “User” by default. A “Vendor” can only view reports of issues not the projects.); and/or 13) Team Name, which may be the name of the team that the user belongs to.

The types of the users may include one or more of the following: 1) User may be authorized to add projects and issues. This is the normal user who is allowed to create projects; 2) Super User (Modify)—who may be the most powerful user in the system and should be reserved for management personnel. All projects and issues may be visible to this super user. This user may further have the ability to modify data regardless of whether she is on the team; 3) Super User (View) may have the capability to view all the projects and issues-on the system regardless of whether she is on the team; 4) Admin Only user may have no capability to modify projects and issues; 5) Vendor may view only reports and those issues to which they have been assigned as team member; and 6) Admin user may add and modify the administrative areas.

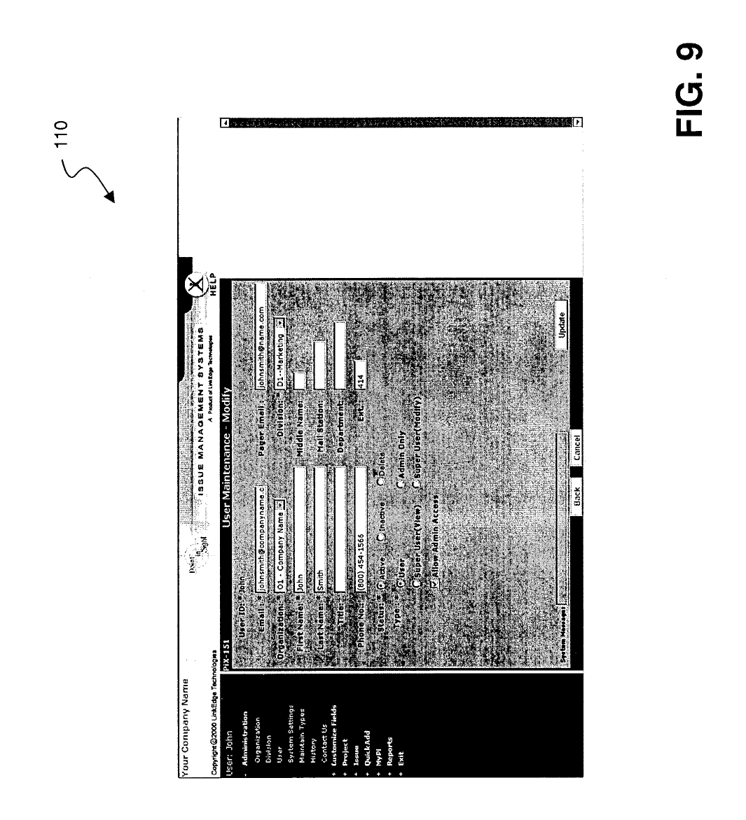

The details of the user information may be modified by clicking on the appropriate user in the table, such as the Users List table of the new user screen 108 of FIG. 8, to bring up a user maintenance screen 110 of FIG. 9. After modifying desired user details, the modification may be stored by clicking an “Update” button on the user maintenance screen 110.

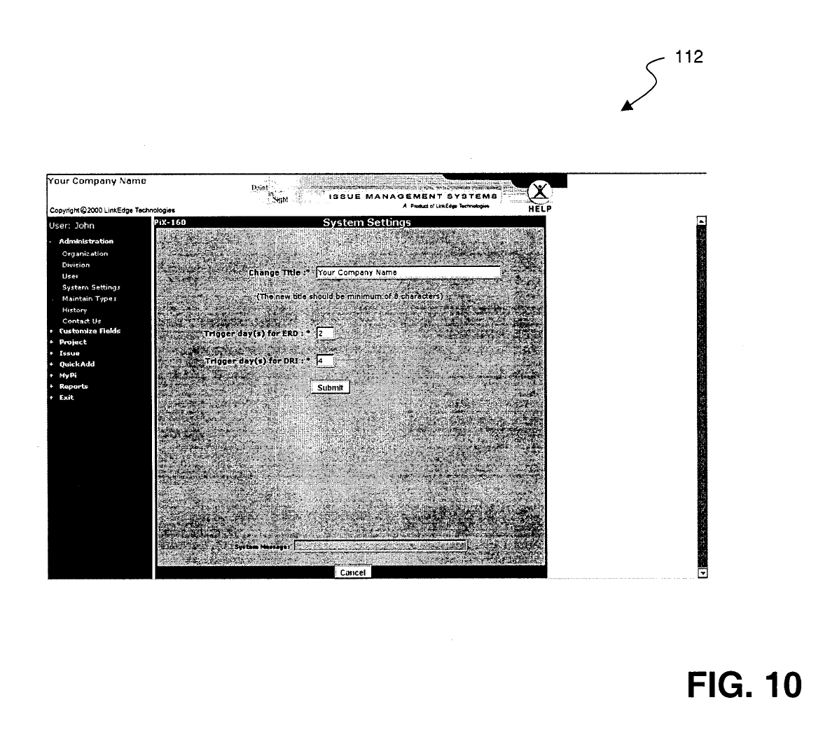

In the issue management system, system settings may allow a user and/or administrator to configure certain aspects of the system to meet her needs. The customization may be applicable for the entire implementation. In the exemplary embodiment, the system settings may also be modified, for example, using a system settings screen 112 of FIG. 10. Using the system settings screen 112, the name of the organization or the title that should appear on the top left-hand corner of each screen may be modified using the “Change Title” field. Further, a “Trigger day(s) for ERD” field may be used to enter the number of days when e-mail alerts should be sent, before the Expected Resolution Date (ERD) passes. In addition a “Trigger day(s) for DRI” field may be used to enter the number of days when e-mail alerts should be sent, before the Date Risk Increases (DRI).

The issue management system of the present invention may include issue types and issue groups, which are fields that classify the issues into various user-defined categories. Once classified, these fields may provide a basis for powerful search capabilities in the issue search functions. The user may define each field to represent a data category that they wish to track. The user may choose up to six types and one group for each issue in the exemplary embodiments. The issue types and group are not necessarily related to each other.

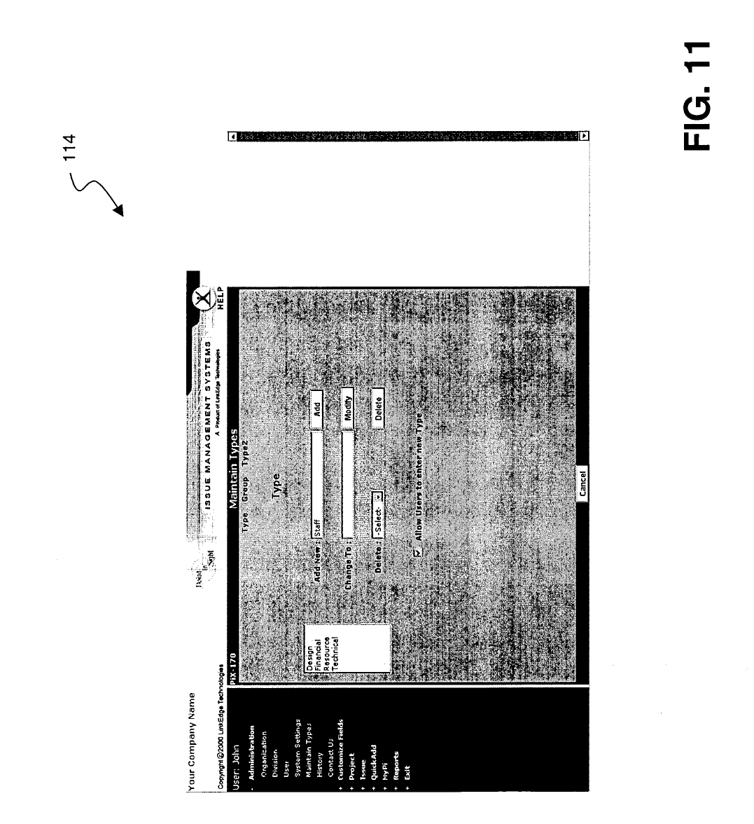

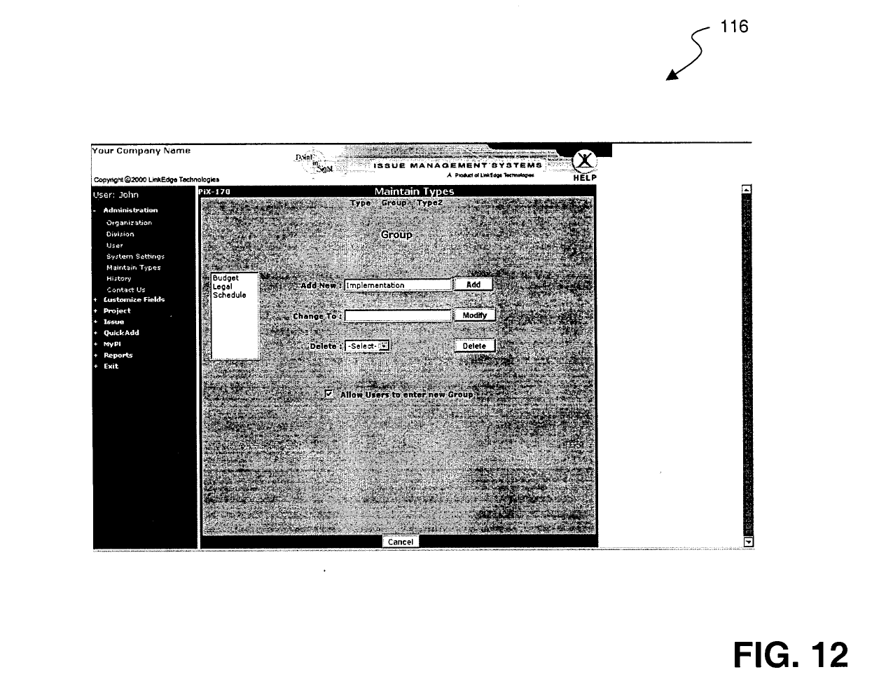

An administrator may add, modify or delete the issue types and issue groups using an issue type screen 114 of FIG. 11 and a group type screen 116 of FIG. 12, respectively. The administrator may check the “Allow Users to enter new Type” box of the issue type screen 114 or the “Allow Users to enter new Group” box of the group type screen 116 while creating an issue to allow users to enter a new issue type or a new issue group, respectively. If the respective box is not checked, the users may be restricted to the type and group to the ones entered by the administrator.

New issues may be added by adding the new issue title and click the “Add” button for the issue on the new issue screen 114. In addition, a “Modify” button may be pressed after selecting the issue to be modified to modify existing issues. Further, the issues may be deleted by selecting the issue and then pressing the “Delete” button.

An administrator may add a new issue group by adding the new issue group and click the “Add” button for the issue group on the issue screen 114. In addition, a “Modify” button may be pressed after selecting the issue group to modify the existing issue group. Further, issue groups may be deleted by selecting them and then clicking the “Delete” button.

In the exemplary embodiment, the issue management system may document the translations automatically. The issue management system may record the type of the change, who made the change, as well as the date and time. The history of the administrative changes may also be made. The history of changes made to administrative information may be viewed by using the history reports.

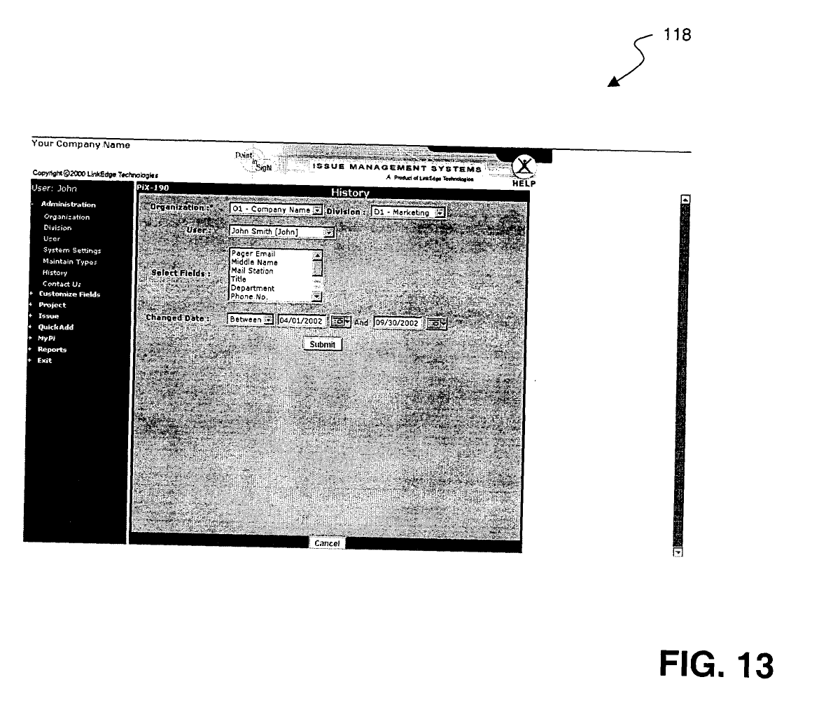

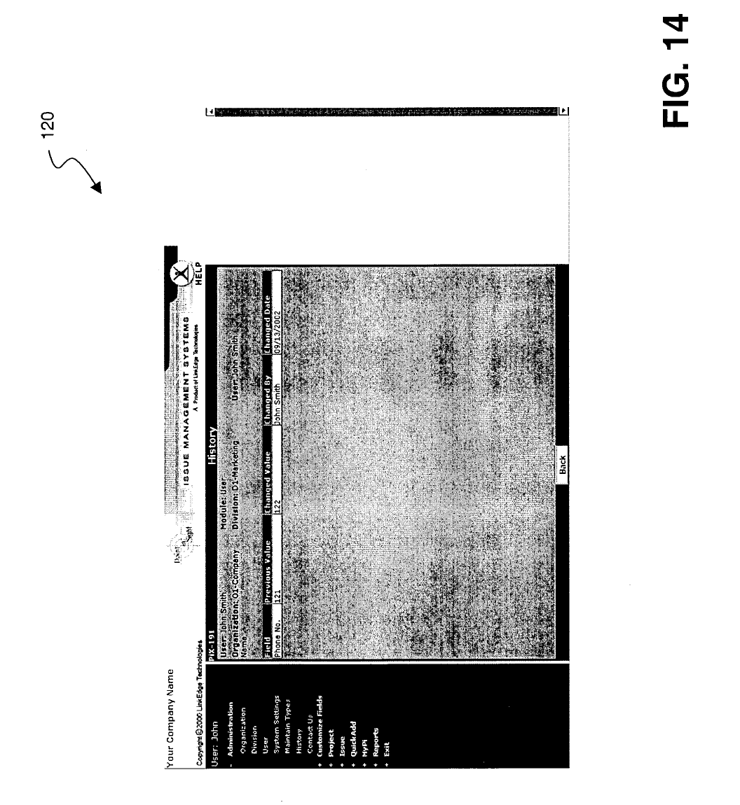

For example, the “History” link under “Administration” on the left window frame may be clicked to bring up a history search screen 118 of FIG. 13. In this screen, the organization, division and/or users may be selected to view the history thereof. For example, to view the history of changes made in the organization, only the that organization should be selected from the drop down menu in the exemplary embodiment. Then, the criteria are selected to specify fields that a search is to be conducted in. Then a “Changed Date” field may be entered to limit the search to between those dates. FIG. 14, for example, illustrates a history view screen 120 that shows a history of changes by a user.

In an exemplary embodiment, users may be imported from a database, such as an address book of an e-mail account, such as an Outlook Express address book.

The fields may also be customized using the “Customized Fields” feature in an exemplary embodiment according to the present invention. Using the “Customized Fields” feature, the application may be customized specifically to meet specific needs. Using this capability, the screens of the issue management system may be configured to be targeted to specific needs. Because a user is allowed to determine what she sees and the data that she collects for each issue, the issue management system is able to adjust to the user's specific needs.

The “Customize Fields” feature may allow the user to configure: 1) which fields she may see on the screen, which may determine the data that the user may collect for each issue; and 2) what a user may wish to call each field. This means that the user may decide the label for each field that is allowed to be customized. This allows a user to focus the application screens to her industry using her particular business lingo. The user may also be able to define each field to be mandatory or optional. This ability allows the user the flexibility to tailor the data entry to her requirements. The selections a user make within “Customized Fields” may take effect for the entire implementation. The administrators are the only ones authorized to make the changes in an exemplary embodiment.

Projects are the third level in the hierarchy of the issue management system in an exemplary embodiment according to the present invention. Projects belong to an organization and division combination. One division may have multiple projects. Any user in the system may create projects. Once created, a project may have multiple issues. As an example, a project could be the case name in the field of law. In distribution, a project could be an organization's customer name.

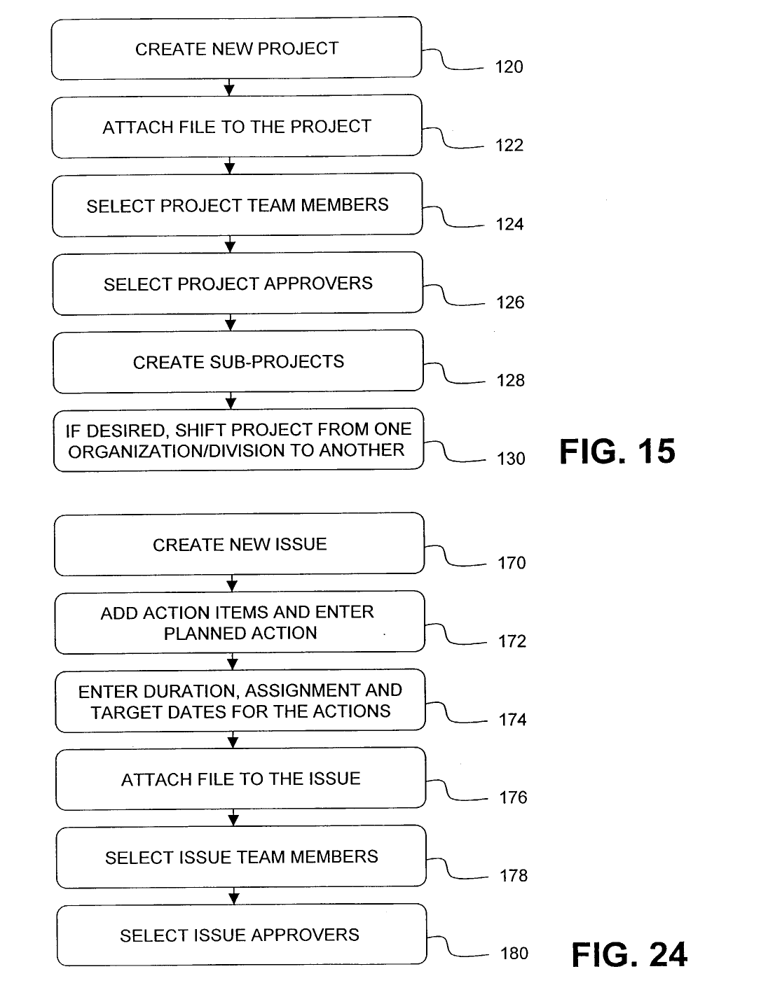

FIG. 15 is a flow diagram that illustrates a process of creating projects in an exemplary embodiment according to the present invention. First, a user creates one or more projects as illustrated in step 120. The user in step 122 may also attach a file (e.g., a document) to the project. In steps 124 and 126, the user selects project team members-and approvers, respectively. The user may also create sub-projects in step 128. Further, the user in step 130 may shift the project from one organization or division to another if desired.

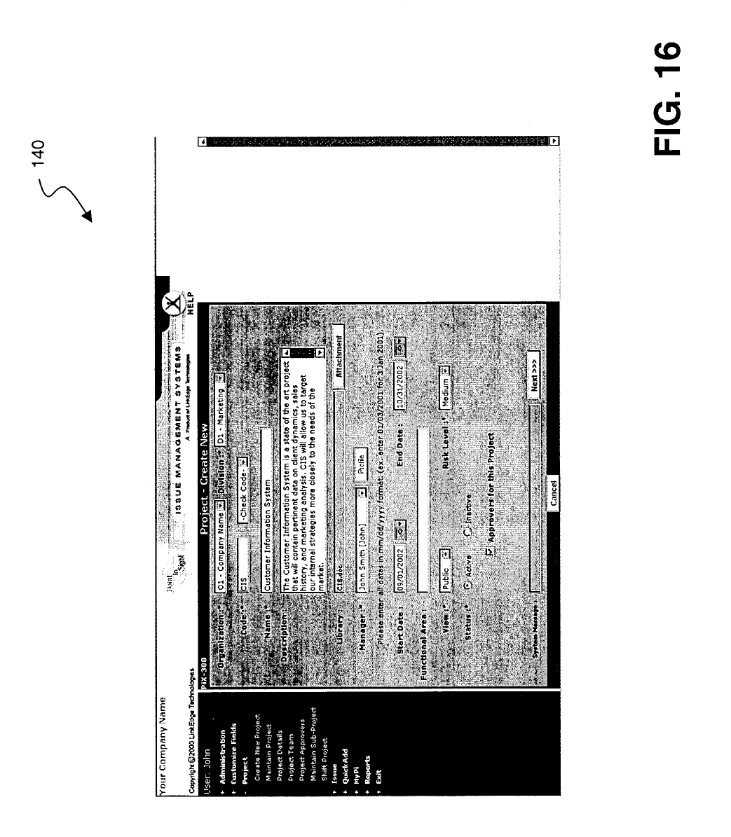

In the exemplary embodiment, a project may be created by clicking on “Projects” on the left window frame, and then clicking on the “Create New Project” link to bring up a new project screen 140 of FIG. 16. Using the new project screen 140, the user may select an organization and a division, which may have default values in the beginning, but may allow for selection of another organization or division, for example, using a drop down menu. Then a project code and a project name should be entered in that order. In the new project screen 150, the description of the project may also be entered.

A user may also attach a file (e.g., a document) to the project using a “Project Library” feature of the new project screen 140. A project manager may be selected for the project from the drop down menu. The menu, for example, may include all the users in the organization. Further, a “Profile” button may be clicked to view the selected manager's details. The current user's name may appear by default when the “Profile” button is clicked. Upon selecting the name of another user, a user may get an informational pop-up box about that user's detail.

The new project screen 140 may also provide for entering start and completion dates for the project, and functional area that refers to the relevant department for which the project is under. In addition, public and private views may be selected, and the risk level of the project (low, medium and high) and the project status may be chosen. Further, an “Approver for this Project” box may be checked to assign Project Level Approvers and/or Project Level Resolution Approvers.

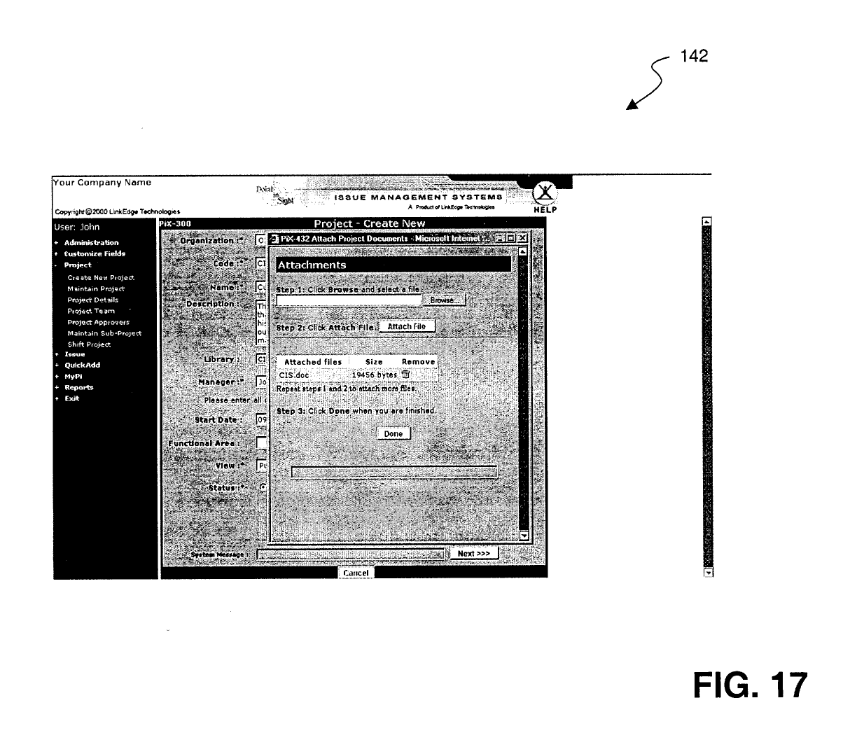

Attachments to the project may be provided by first clicking on an “Attachment” button-on an attachments screen 142 of FIG. 17. Then a “Browse” button may be clicked to locate the file to be attached, and then an “Attach File” button may be clicked to attached the document. The attachment may be deleted by clicking on a trash bin icon next to the document. Once the file appears as attached, a “Done” button may be clicked. In the exemplary embodiment, an unlimited number of documents may be attached. Further, there is no size limit on the documents attached in the exemplary embodiment. There may be limits to the size or the number of attached documents in other embodiments.

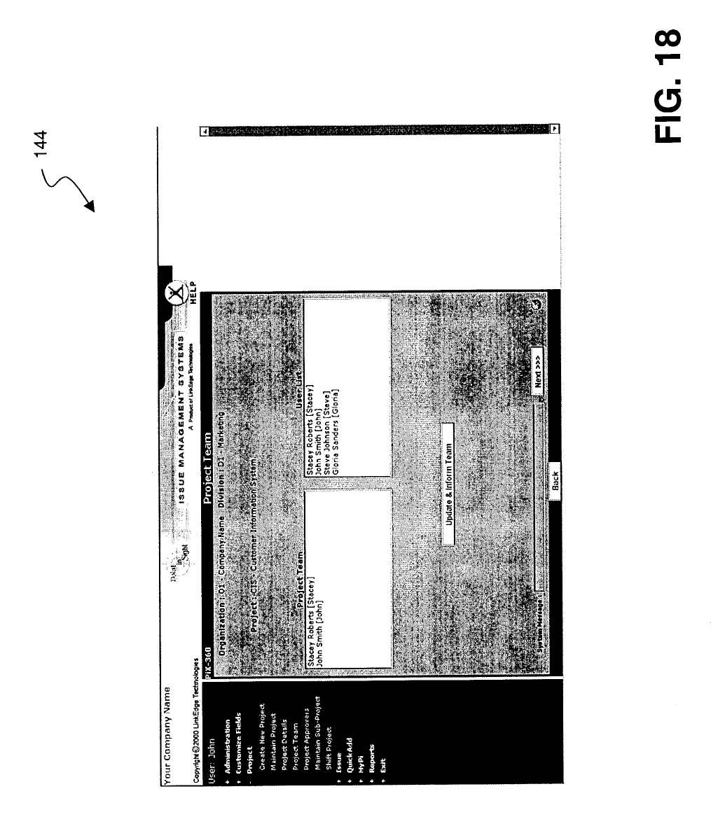

A project team is a group of users who are chosen by the project creator or manager. Members of this group are authorized to create issues; for the project. For example, a project team may be created by adding a new project, or by clicking the “Project Team” link on the left window frame. This may bring up a project team screen 144 of FIG. 18, for example. The project team screen 144 illustrates a User List on the right side of the screen. The User List may illustrate names of all the users in the system. A user's name may be clicked to add the user to the project.

To remove users from a project, the user's name in a “Project Team” list may be clicked. The “Project Team” list may be on the left side of the project team screen 144. In the exemplary embodiment, the project team members who are in open or hold issue teams may not be removed. To remove them, they should first be deleted from the issue team. Once all the team members have been selected, an “Update & Inform Team” button may be clicked to send an e-mail to the project team members.

The issue management in an exemplary embodiment provides for approvers who may be chosen by the project manager or project creator. There may be two types of approvers, project level issue approvers and project level resolution approvers. The project level issue approvers are those who review and approve the description of the issue.

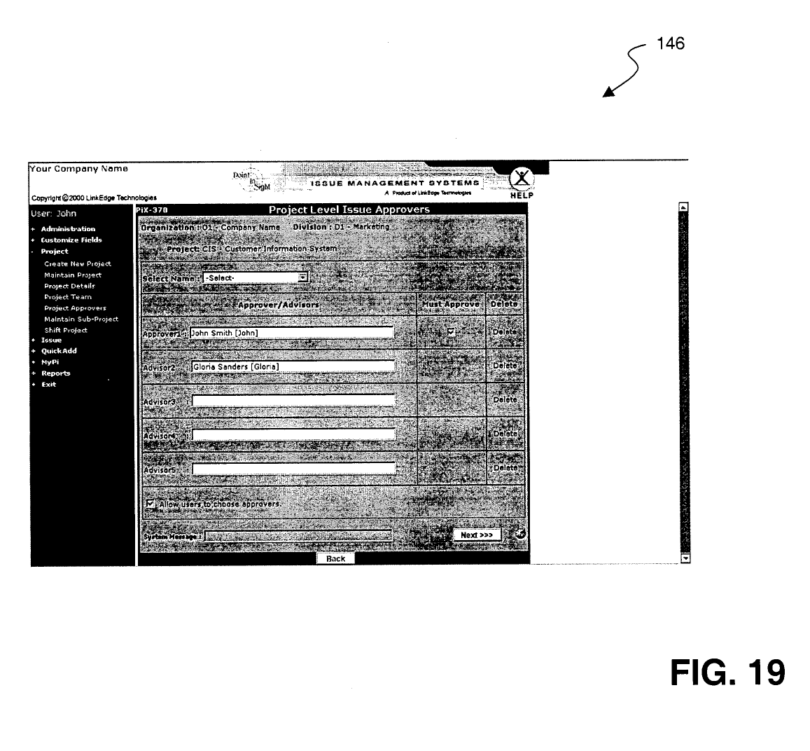

In the exemplary embodiment, project level issue approvers may be selected by the project manager or project creator, for example, using a project level issue approvers screen 146 of FIG. 19. In the exemplary embodiment, up to one approver and four advisors may be chosen from the user list. Different number of approvers and/or advisors may be selected in other embodiments. Issues created under this project may have approvers and advisors from this list unless the manager allows otherwise.

To select the approver, the appropriate user name should be selected from the “Select Name” drop down menu. The user may have an option to choose one mandatory approver by checking the “Must Approve” box. To select advisors, the appropriate user names may be selected from the “Select Name” drop down menu. Advisors may be requested to submit comments for the issue. The users may be allowed to choose different approvers when creating an issue by checking the “Allow users to choose approvers at issue level” box. If this box is not checked, the issue creators may be limited to the list of approvers that are selected in the project level issue approvers screen 146. To remove an approver/advisor, a “Delete” link may be clicked.

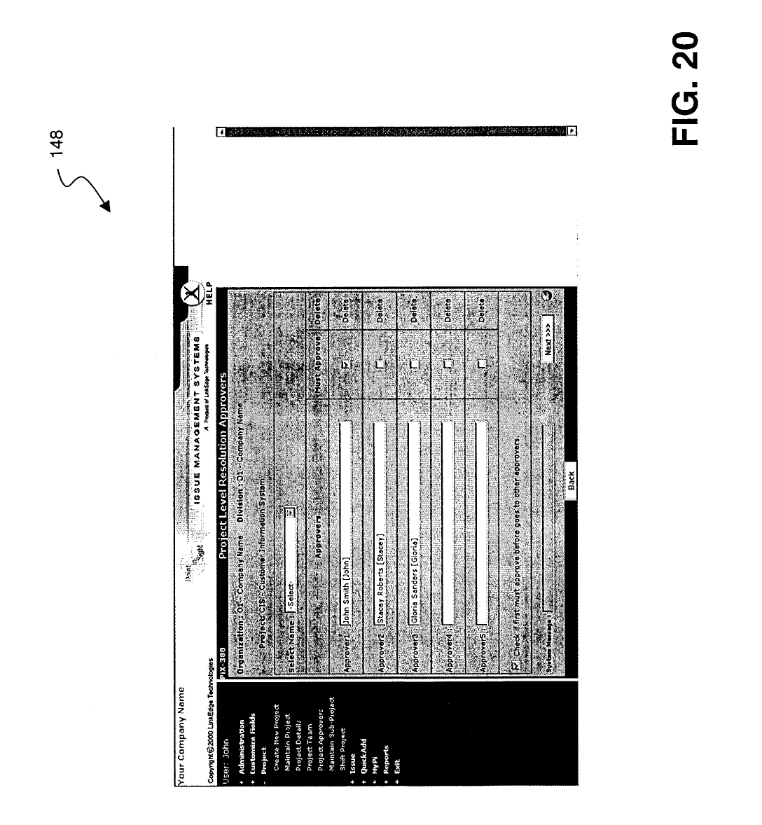

Similarly in the exemplary embodiment, project level issue resolution approvers may be chosen by the project manager or project creator. The project level resolution approvers may be those who approve the resolution of the issue. In an exemplary embodiment, up to five project level resolution approvers may be selected from the user list using, for example, a project level resolution approvers screen 148 of FIG. 20. Issues created under this project may have approvers and advisors from this list unless the manager allows the issue creators to choose from outside the list.

To select the approvers, the appropriate user names may be chosen in the “Select Name” drop down menu. The creating user has an option of mandating that the first approver approve the resolution before it goes to the other approvers by checking the “Check if first must approve before goes to other approvers” box at the bottom of the project level resolution approvers screen 148. Further, the creating user has an option to make approvers mandatory by checking the “Must Approve” box. In addition, an approver may be removed by clicking on the “Delete” link.

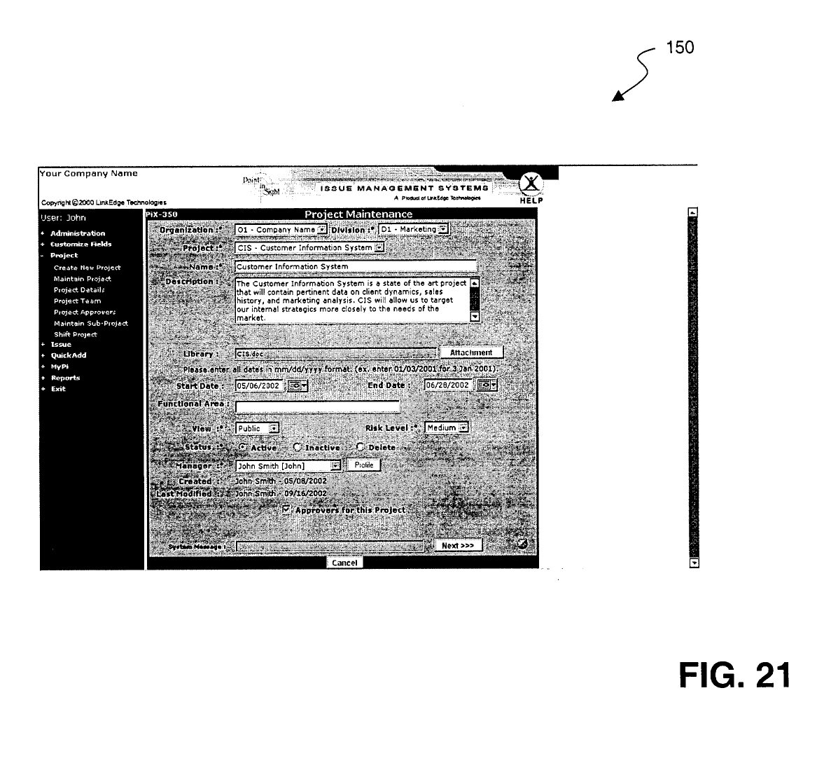

In the exemplary embodiment, once a project has been created, it may be maintained by the project manager and project creator using the project maintenance screens. When the “Maintain Project” link or the “Project Details” link on the left window frame is clicked, the organization and division may be initialized by default according to the user status, and a project maintenance screen 150 of FIG. 21 may be brought up. Then a user may choose the appropriate project code for which she is authorized to view. The Changes may be made to the default information.

It should be noted that the projects should not be made inactive if sub-projects exist under it. If the “Maintain Projects” link has been clicked, the “Next” button should be clicked to move on to the next screen to update the Project Team, Project Level Issue Approvers, Resolution Approvers, etc. If the “Project Details” link has been clicked, the “Modify” button should be clicked to update the project details.

The issue management system in an exemplary embodiment according to the present invention provides for an ability to create a project hierarchy. A sub-project is a project placed under another project, which may be referred to as a parent project. In the exemplary embodiment, an unlimited number of sub-projects may be added to a project. In order to do this, all projects, no matter where they will be in the hierarchy should be defined.

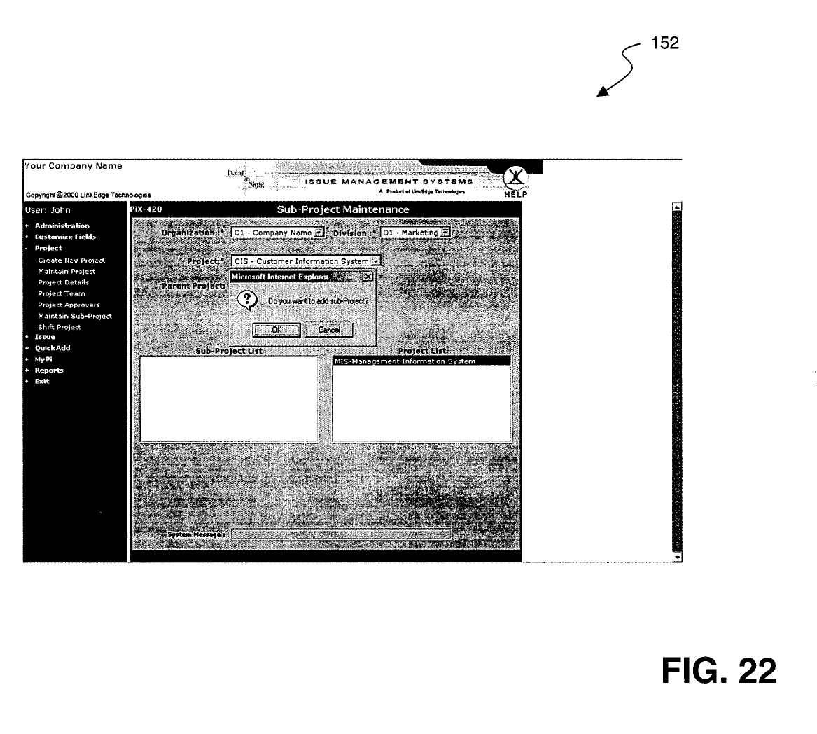

In the exemplary embodiment, a sub-project may be created by clicking on the “Maintain Sub-Projects” link on the left window frame to bring up a sub-project screen 152 of FIG. 22. In this, the organization and division may be initialized by default according to the name of the user. The appropriate project code may be selected from the drop down menu. Then, project(s) may be clicked in the Project List to add sub-projects to.

The sub-projects selected should appear in the Sub-Project List. The right table, “Project List” may display all the projects in the specific organization-division combination. If the current project has a parent project, it may be displayed. A sub-project may be removed by clicking on the project in the “Sub-Project” list. If the sub-project in the list has other sub-projects, the (tree) structure of the sub-project may remain intact, until the other sub-projects have been removed.

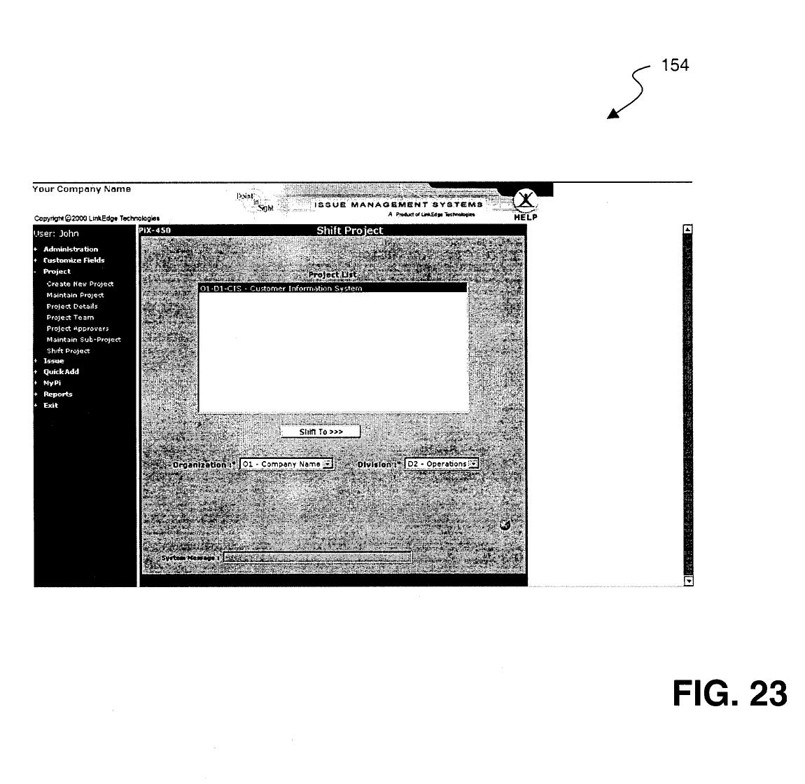

In the exemplary embodiment, projects may be shifted from one organization and/or division to another. In the exemplary embodiment, there should be no users using the application when shifting a project. A user may shift and merge projects by clicking on the “Shift Projects” link on the left window frame to bring up a shift project screen 154 of FIG. 23. The shift project screen 154 may have a “Project List” which lists the Organization, Division and Project Name of all active projects. An appropriate project or sub-project is selected from the Project List. The user should click on the project in the Project List that she desires to shift. Then the user should select the Organization and Division from the drop down menu. Finally, the user should click on the “Shift To” button to save the project in its new location.

An issue may be defined as any information that needs to be documented or followed up. Issues belong to a project and may be created by any member of the project team in the exemplary embodiment. In the case where a project is defined as a case, issues may be elements of the case. In distribution, where the project is defined as a customer, issues may be purchase orders executed for that customer.

FIG. 24 is a flow diagram that illustrates a process of creating issues in an exemplary embodiment according to the present invention. The user may create a new issue in step 170. In steps 172 and 174, respectively, the user may add action items, enter planned action, and enter duration and assignment and target dates for the actions. In addition, the user may attach a file to the issue in step 176. Further, in steps 178 and 180, the user selects issue team members and issue approvers, respectively.

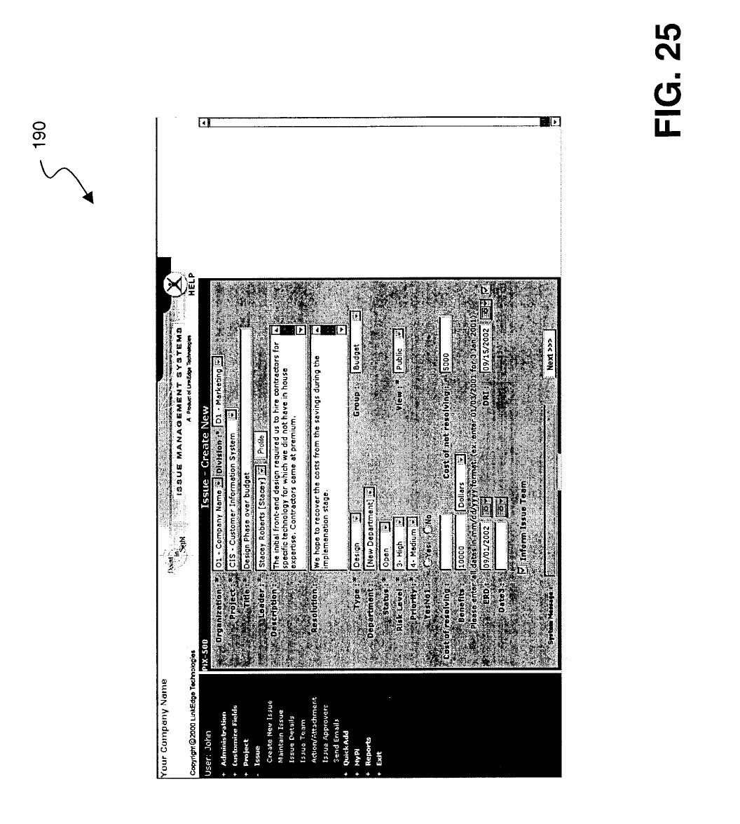

To create a new issue, for example, a “Create New Issue” link on the left window frame may be clicked to bring up a new issue screen 190 of FIG. 25. The organization and division may be initialized by default according to the user name of a user. All projects with an assigned “Project Code” may appear in the drop-down menu. A project code may be selected to create an issue for that project.

In the “Title” field, the name of the issue should be entered, and in the “Leader” field, the name of the leader (i.e., issue team leader) for the issue should be selected and entered. The current user's name may appear as the leader by default. Upon selecting the name of another user, an informational pop-up box about the user may be provided.

In the “Description” field, the description of the issue may be entered, and the resolution for the issue may be entered in the “Resolution” field. The issue resolution is the solution to the problem that has been documented. It may be created and modified by any member of the issue team. The description may be developed over time as the solution becomes clear.

Size Ratio may also be entered if applicable. Further, the issue type may be selected from the drop down menu or, if allowed, “New Issue Type” may be selected to create a new category. A pop-up box may appear after clicking a “Next” button, and new issue type may be entered in this box. Issue types may also be selected.

The status of the issue may also be selected in the “Status” field. If Issue status is selected as “Resolved,” a resolution summary may also be entered in the “Resolution” field. In the “Risk Level” field, level of risk for the issue may be entered. The options may include, but are not limited to: 1—critical, 2—urgent, 3—high, 4—medium and 5—low. A “Risk Increase” box may also be available, and by checking it, an e-mail alert may be sent to the user's pager e-mail address.

The issue group may be entered from the drop down menu, or, if allowed, “New Issue Group” may be selected to create a new category. A pop-up box may appear after clicking the “Next” button, and the new issue group may be entered in this box. An issue view may be entered as either public or private in the “View” field. Further, an issue priority may be selected in the “Priority” field as: 1—critical, 2—urgent, 3—high, 4—medium or 5—low. In an exemplary embodiment, an e-mail alert may be sent to the issue team when an issue is assigned a “critical” priority.

Expected resolution date may also be entered in the “ERD” field when resolution is expected. In the “DRI” field, date when risk increases may be increases to signify that the risk is expected to increase after this date. Date3 through 8 may also be entered as applicable if available.

Some of the other fields may include one or more of: YesNo1 through YesNo6 to select Yes or No if applicable; “Embroidery/Print” field to select one if applicable; “Air/Sea” field to select if applicable; cost of resolving the issue; cost of not resolving the issue; Benefits, which is a unit of measurement from the drop down menu, in which an appropriate amount may be entered; and “Inform Issue Team” box to be checked in order to send out an e-mail to inform the team that this issue has been added. For example, the issue number may be assigned sequentially from I1 in the exemplary embodiment.

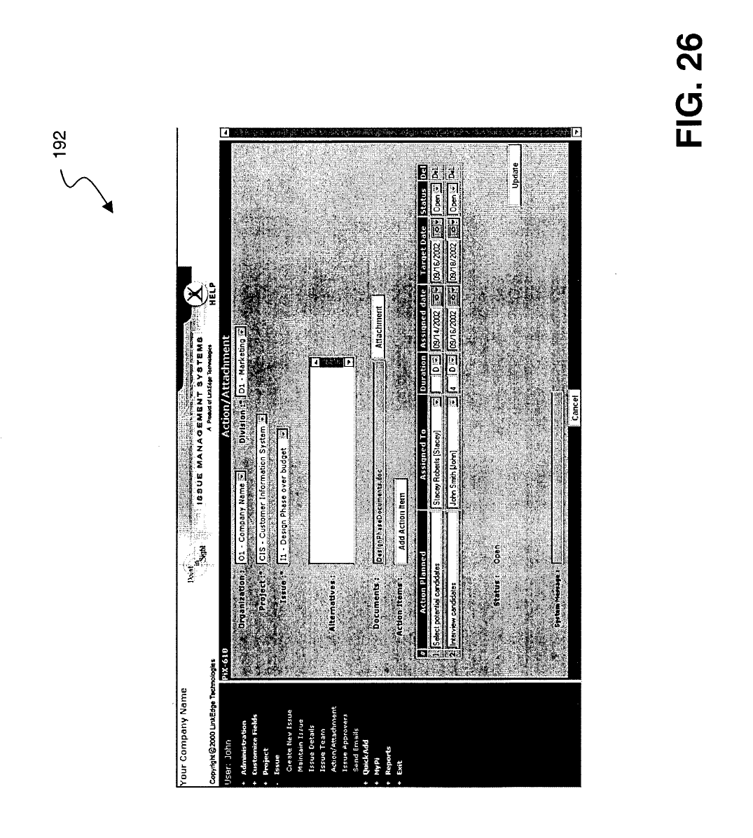

An action item may allow a user to make assignments for an issue to various team members. For example, an action item may be created by clicking on the “Action/Attachment” link on the left window frame to bring up an action/attachment screen 192 of FIG. 26. In the “Alternatives” field, issue impact on the organization may be entered. Further, an “Add Action Item” button may be clicked to enter the actions that may be taken towards this issue.

In the “Action Planned” field, the description of the action for the issue may be entered. In the “Assigned To” field, a member of the issue team assigned to the action may be entered. In the “Duration” field, the number of days and/or hours may be entered. In the “Assigned Date” field, the assigned date for the action may be entered. In the “Target Date” field, the target date for the completion of the action may be entered. In the “Status” field, the action may be given a status of either “open” or “closed.”

An “Attachment” button may be clicked and a “Browse” button may be clicked to locate the file to be attached, and to attach the file. The attachment may be deleted, for example, by clicking on the trash bin icon next to the document. In the exemplary embodiment, an unlimited number of documents may be attached, and there may be no size limit on the documents attached. An issue status may be defaulted from what was selected on the “Issue—Create New” screen (or new issue screen).

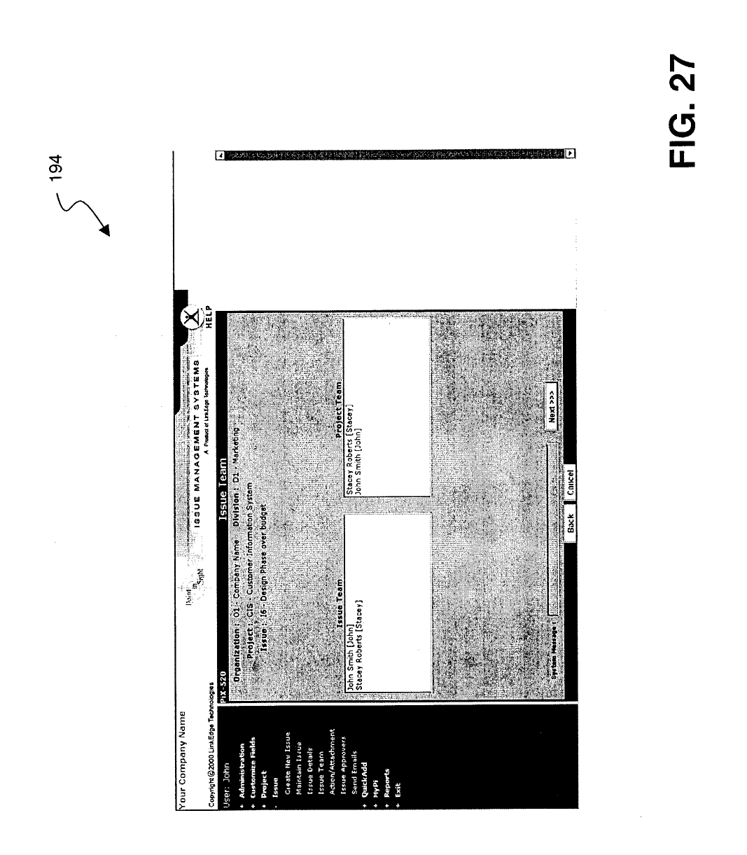

In an exemplary embodiment, an issue team is a group of users who are chosen and modified by the project manager or creator. Members of this group, for example, may be authorized to modify the issue details. An issue team may be created after adding a new project, or by accessing the “Issue Team” link from the left window frame, for example, to bring up an issue team screen 194 of FIG. 27. A “Project Team” list may be found on the right side of this screen with the names of all the project team members. The project team members may be added to the issue team by clicking on their names in the “Project Team” list. To remove members from the issue team, the member's name in the “Issue Team” list may be clicked. When all the team members have been selected, a “Next” button or a “Update Issue Team” may be clicked to enter the changes.

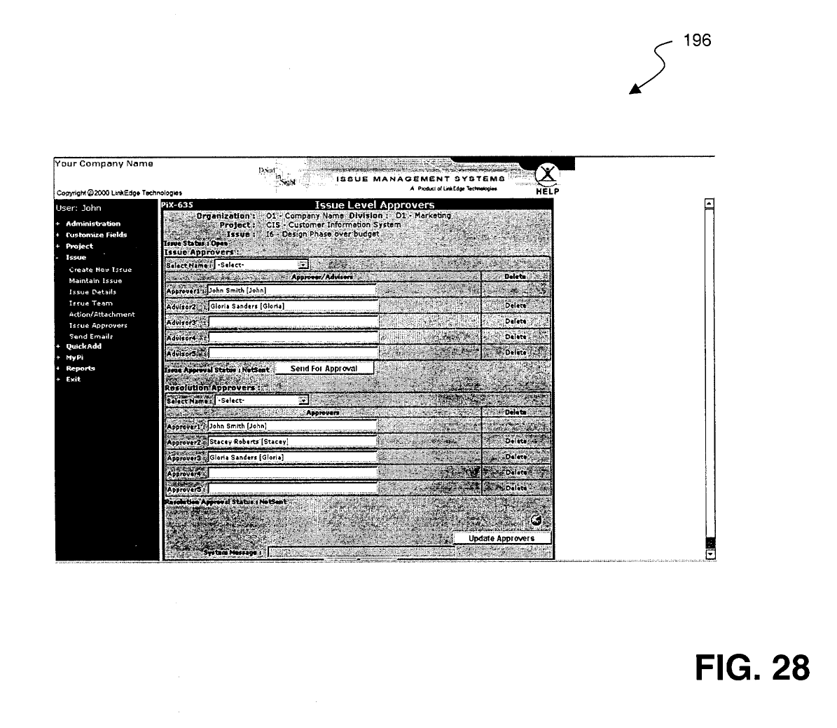

Issue approvers may be chosen and modified by the issue team leader or issue creator using an issue level approvers screen 196 of FIG. 28 if authorized by the project manager. There are two types of approvers in the exemplary embodiment: 1) Issue Level approvers; and 2) Issue Level Resolution approvers. The issue level approvers are those who may review and approve the description of the issue. The approvers and advisors may be limited to those chosen at the project level, unless the project manager has allowed otherwise.

Depending on the default set at the project level, the approvers may be selected from a drop down menu or by default. If selecting approvers at issue level is allowed, the user may get a list of user names to choose as issue approvers. Appropriate user names may be selected from a “Select Name” drop down menu. To remove an approver/advisor, a “Delete” link may be clicked.

Issue Level Resolution approvers are those who may approve the resolution of the issue. The approvers may be limited to those chosen at the project level, unless the project manager has allowed otherwise. Depending on the default set at the project level, the approvers may be selected from a drop down menu or by default. If selecting approvers at issue level is allowed, a list of user names to choose as resolution approvers may be provided in the issue level approvers screen 196. Appropriate user names may be selected from the “Select Name” drop down menu. An “Accept” check box, if applicable, may be checked for confirmation of this information. To remove an approver, a “Delete” link may be clicked.

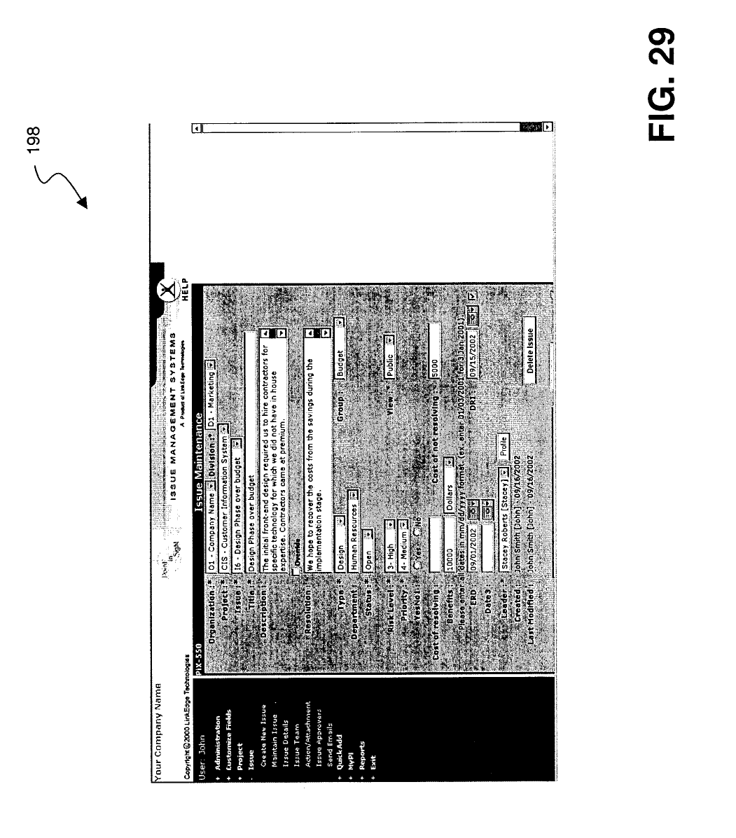

In an exemplary embodiment, once an issue has been created, it may be maintained by the issue team using an issue maintenance screen 198 of FIG. 29. A “Maintain Issue” link or an “Issue Details” link on the left window frame may be clicked, for example, to bring up the issue management screen 198. For example, the organization and division may be initialized by default according to the user name of the user. The user may choose the appropriate project code and issue number for which she is authorized to view. If the user is an issue leader or creator, that user may delete an issue, for example, by clicking on a “Delete Issue” button. The “Delete Issue” button may not be active if comments have been submitted for the issue.

The project manager may give the issue team an “Override Authority” to change the issue description or resolution once the issue has been sent for approval. Members of the issue team may check the Override box next to the issue description/resolution. A permission to override may be sent to the project manager; once approved, an e-mail may be sent to the team that override authority has been granted. Further, an e-mail may be sent to the project manager once changes to the issue description or resolution have been made.

A “Next” button may be clicked if “Maintain Issues” link has been selected to move on to the next screen to update the Issue Team, Issue Approvers and/or Resolution Approvers. If the user is not the issue leader or creator, the user may not get screens to modify the issue team or approvers. If the “Issue Details” link has been clicked, a “Modify” button may be clicked to update the issue details.

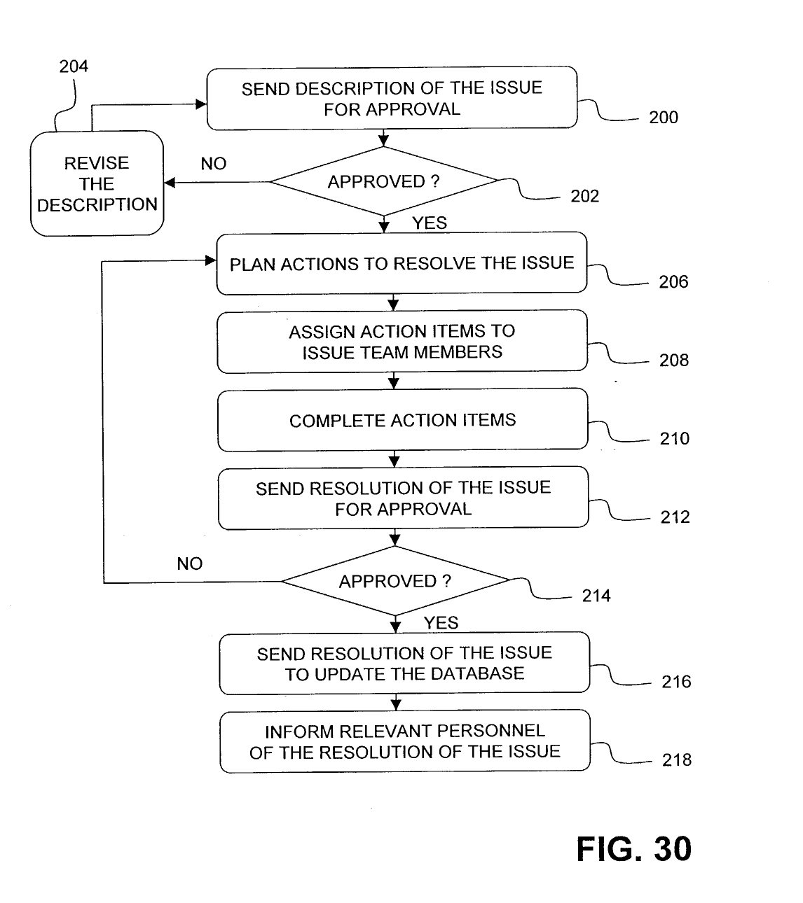

FIG. 30 is a flow diagram that illustrates a process of resolving an issue in an exemplary embodiment according to the present invention. In step 200, the issue team (e.g., issue team leader) sends a description of the issue to an issue level approver for approval. The description of the issue may be sent via e-mail directly to the issue level approver or it may be sent to the database updater, and be forwarded automatically by the e-mail sender to the issue level approver. The description of the issue may also be sent to one or more advisors.

If the description is not approved in step 202, the issue team is informed of the non-approval, and the issue team should revise the issue description in step 204. If, however, the description is approved, the issue team is informed of the approval, and the issue team proceeds to plan actions to resolve the issue in step 206. The approval or non-approval by the issue level approver may be sent directly via e-mail to the issue team or it may be sent to the database updater to update the database, and, then be forwarded via the e-mail sender to the issue team.

In step 208, based on the planned actions, action items to be completed for the resolution of the issue are assigned to the issue team members. For example, the issue team leader may assign them to the team members via e-mail directly or by sending an e-mail to the database updater, to be forwarded to the respective team members. After the team members complete the action items in step 210, the team members prepare and send a resolution of the issue to an issue,level resolution approver for approval in step 212. The resolution of the issue may be sent via e-mail directly to the issue level resolution approver or it may be sent to the database updater, and be forwarded by the e-mail sender to the issue level resolution approver. The resolution of the issue may also be sent to one or more advisors.

If the resolution is not approved in step 214, the issue team members are informed of the non-approval directly by the issue level resolution approver or via the database updater and the e-mail sender. At this point, the issue team members may have to repeat one or more of steps 206, 208 and 210 to prepare a revised resolution, and send it to the issue level resolution approver in step 212. If, however, the resolution is approved, the issue team (e.g., issue team leader) sends the resolution in step 216 to the database updater to update the database. The database in step 218, in turn, may inform (via the e-mail sender) relevant personnel of the resolution of the issue.

A “Send e-mails” feature may provide a user an ability to notify people that are not in her issue team about a particular issue. This capability may also allow the user to notify anyone with an e-mail address who may not even be in her organization. The user may simply give information and enter an optional greeting to send out a pre-formatted e-mail with all the pertinent information.

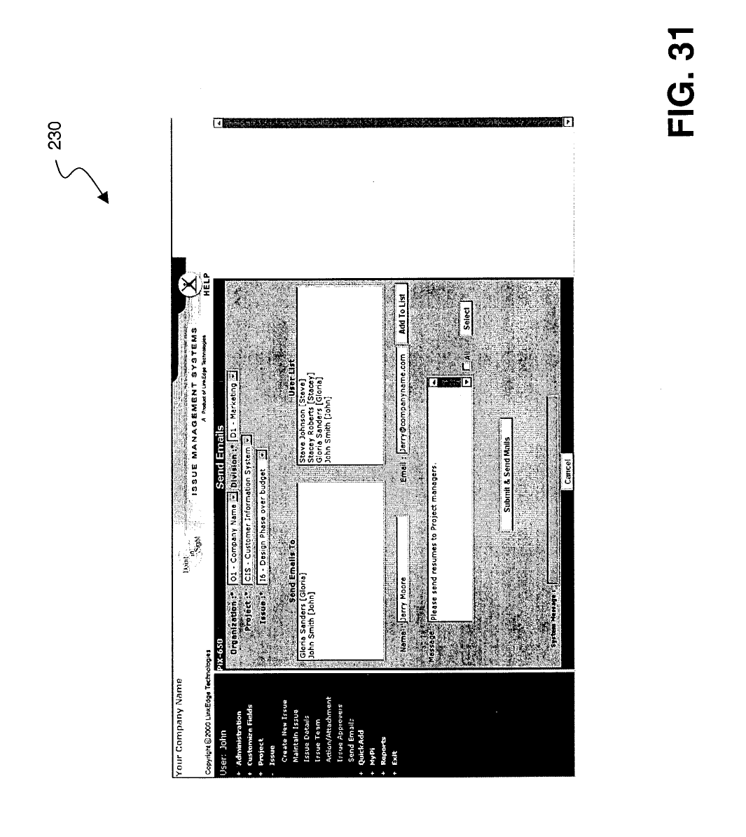

The e-mails, for example, may be sent by clicking on a “Send E-mails” link on the left window frame to bring up a send e-mails screen 230 of FIG. 31. The organization and division may be initialized by default according to the user name of the user. The user may select a project code and issue number. The user may also click on the user names that she would like to send an e-mail to from the “User List.” The names selected may appear under the “Send E-mails To” box.

If the user would like an e-mail to be sent to a person not in the user list, that person's name and e-mail address may be entered. An “Add to List” button may be clicked to add a new person to the list. The user may also be able to enter comments and submit them with the e-mails. These comments, for example, may be the greeting the e-mail will begin with. Additionally, these comments may also be retained in the list of comments for the issue.

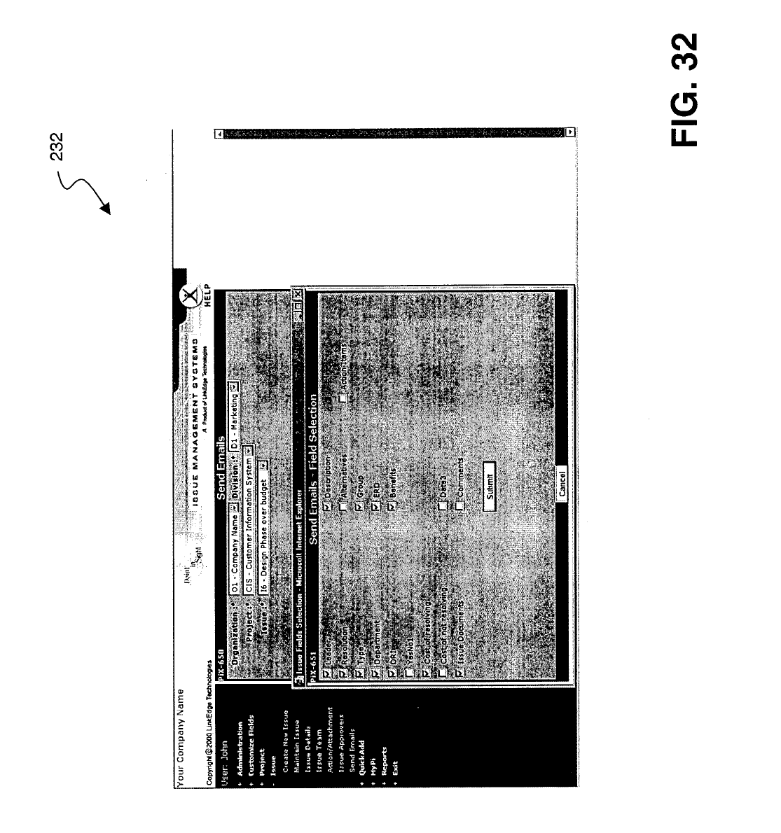

The user may also check the “All” box if she wants all the issue's details to be submitted with the e-mail or click the “Select” button to choose specific fields that she would like to include in the e-mail to bring up a Field Selection screen 232 of FIG. 32. A “Submit and Send Mails” button may be clicked to send the e-mails. The users who have been sent e-mail may have the number of previously sent- e-mails and the date on which the last e-mail was sent. In an exemplary embodiment, an administrator may control e-mail triggers. Triggers may be set for x number of days before the resolution date and the risk date.

A Quick Add feature provides for a quick and easy way to add an issue or multiple issues to a project. The Quick Add functionality allows the users to default some fields to pre-determined values so that creating issues is a fast process. The critical fields of an issue, for example, may all be displayed on a single screen.

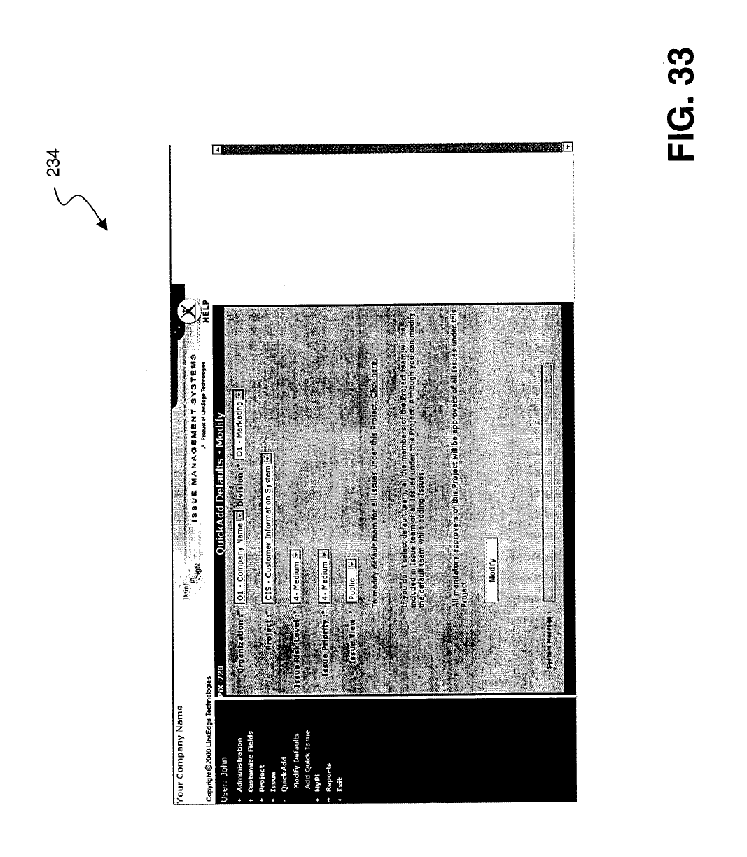

In an exemplary embodiment, the “Modify Defaults” link on the left window frame may be clicked to bring up a quick add defaults screen 234 of FIG. 33. The organization and division may be initialized by default according to the user name of the user. A project code may be selected for which the defaults options have to be set.

The following defaults may be modified by; selecting the drop down menus for: :1) Issue Risk Level—options are 1—critical, 2—urgent, 3—high, 4—medium and 5—low; 2) Issue Priority—options are 1—critical, 2—urgent, 3—high, 4—medium and 5—low.; and 3) Issue View—options are public and private. To modify the “default issue team” for all issues under this project, the user may click on the link, “Click here.” By default, all the members of the project team may be included in the “default issue team.” In the exemplary embodiment, the “default issue team” may be changed while adding issues. All mandatory approvers of this project may be approvers of all issues under this project. After all the changes have been made, a “Modify” button may be clicked to save the modifications.

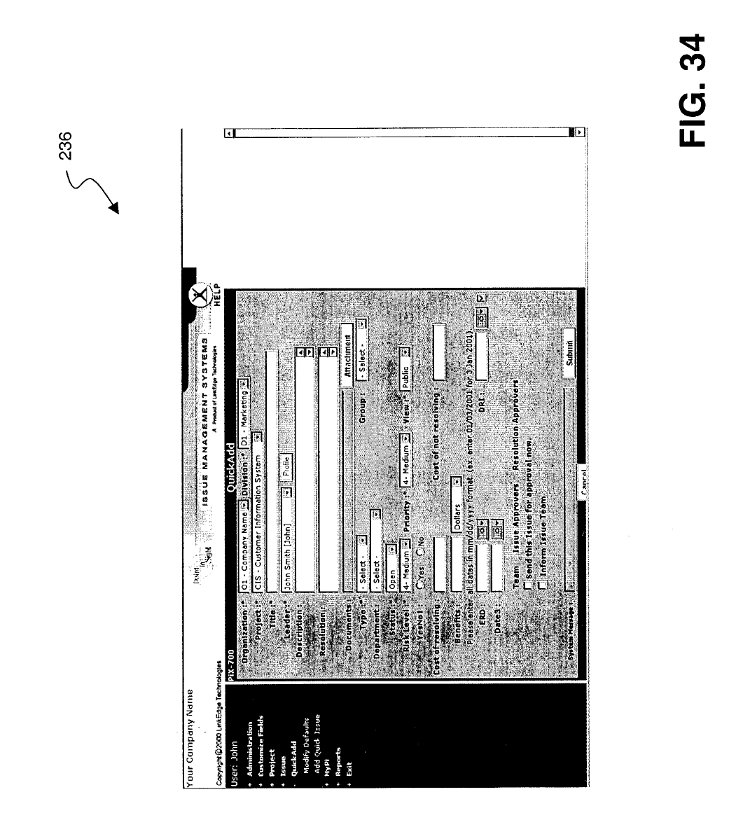

By clicking on an “Add Quick Issue” link on the left frame window, the user may bring up a quick add screen 236 of FIG. 34. The organization and division may be initialized by default according to the user name of the user. A project code may be selected to create defaults for that project's issues. In the “Title” filed, the name of the issue may be entered. Further, an issue team leader may be chosen for this issue. The current user's name may appear in the “Leader” field by default. If the user wishes to change the default, the user may select another user from the drop-down menu, and upon selecting the name, the user may get information pop-up about the user (e.g., user's detail).

In the “Description” field, the user may enter the description of the issue, and the user may enter the resolution for the issue in the “Resolution” field. Further, number for each size ratio may be entered in the “Size Ratio” field if applicable. In the “Type” field, the issue type may be selected from the drop down or “New Issue Type” may be selected. A pop-up box may appear after the user clicks a “Next” button, and a new issue type may be entered in the pop-up box.

A type of issue (e.g., Type2 through Type6) may be selected in the “Type” field if applicable. Further, an issue group may be entered in the “Group” field if applicable. The user may enter the date when a resolution is expected in an “ERD” (Expected Resolution Date) field. Further, the user may enter the date when the risk is expected to increase in a “DRI” (Date Risk Increases) field. In addition, Date3 through Date4 may be entered if applicable, and “YesNo1 through YesNo6 ”, “Embroidery/Print”, “Air/Sea” and “Cost of resolving” may all be entered.

The status of the issue may be selected using “Status” field. The options for the issue status are open, hold or resolved. Using the quick add screen 236, defaults for Risk Level, Priority and View may be modified. A “Select Issue Team” link may be clicked to select the issue team for the issue. By default, all the members of the project team may be included in the “default issue team,” and the “default issue team” may be changed while adding issues. An “Issue Approvers” button may be clicked to modify the issue approvers. If the optional approvers are not deleted, all mandatory and optional approvers selected at the project level may be automatically selected for this issue.

A “Resolution Approvers” link may be selected to modify the resolution approvers. If the optional approvers are not deleted, all mandatory and optional approvers selected at the project level may automatically be selected for this issue. A “Send this issue for approval now” button may be checked to send the issue for approval. The issue may also be sent for approval at a later time by clicking on an “Approver Issue” link on the left window frame. An “Inform Issue Team” box may be checked to send out an e-mail to inform the team that this issue has been added. Then a “Submit” button may be clicked to add the issue.

An exemplary embodiment according to the present invention may provide the user an ability to see her own customized information by providing a “Dashboard” that allows the user to monitor those projects and issues that are of high priority to her and an “Index” of her own projects and issues, what her role is within them, and where they are in the issue life cycle.

The “Dashboard” allows the user to see the projects and issues that she determines are of high priority to her. In essence, the dashboard has everything that a user needs to take action on. The user may view on the dashboard one or more of the following: 1) what action items are assigned to the user; 2) what is coming due in the next x number of days; 3) which of the user's issues are at risk; 4) what is in the user's inbox for her approval or advice; 5) what does the user have to send for approval; and 6) how many issues were due, overdue, created and resolved in the last period. Of course, a user may also view other types of information and data that is of interest to her on the dashboard.

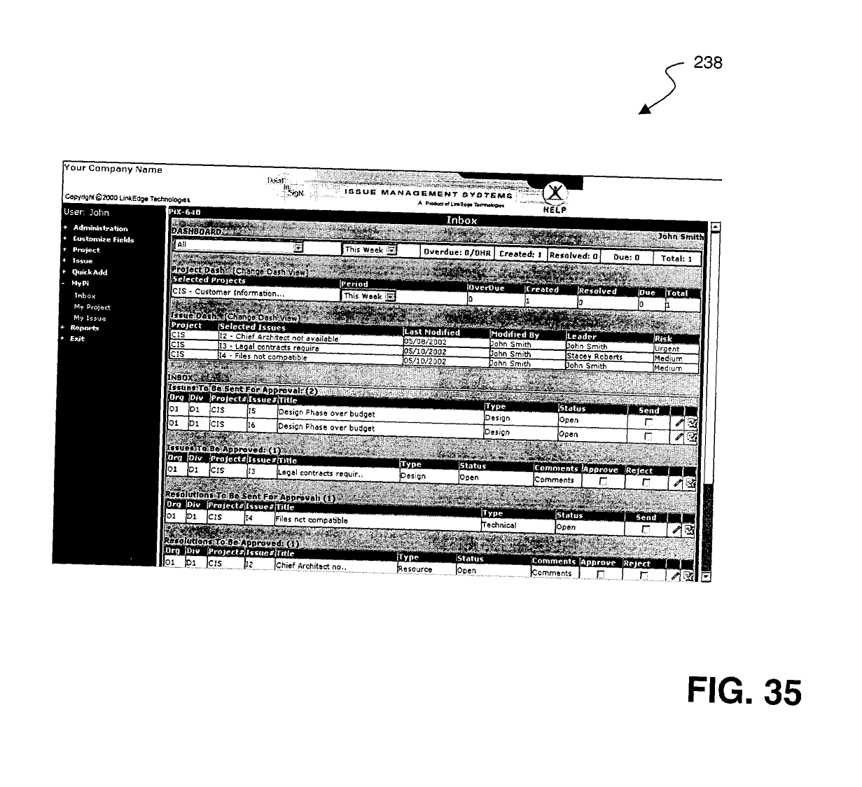

For each project a user selects, she may view the number of Overdue, Created, Resolved, Due and Total issues. she may also select more than one project and view the number and status of the issues. The user, for example, may bring up the “Dashboard” by clicking an “Inbox” link on the left frame window to bring up an inbox screen 238 of FIG. 35. The user may select the “Project” and the time period from the Dashboard drop down menu. The user may elect to view issues under the project within this week, last week, this month or last month. The user may also view the number of Overdue, Created, Resolved, Due and Total issues for the selected project.

In order to change the project list, a “Change Dash View” link under “Project Dash” may be clicked. Also, the “Dash View” box may be clicked for the projects that are of high priority to the user. The user may be able to view these projects in her project dashboard. The user may then click the “Submit” button to update, and click a “Back” button to return to her Dashboard. The Issue Dashboard may allow the user to select those issues that she wants to monitor closely. She may also view when it was last modified, who modified it, the issue leader and risk level.

To change the list of issues, the user may click the “Inbox” link on the left frame window to bring up the inbox screen 238 of FIG. 35 and click the “Change Dash View” link under “Issue Dash.” The Project may be selected from the drop down menu, and the “Dash View” box may be checked for the issues that are of high priority to the user. The user may be able to view these issues in her Issue Dashboard. The user may click “Submit” button to update and click “Back” button to return to her Dashboard.

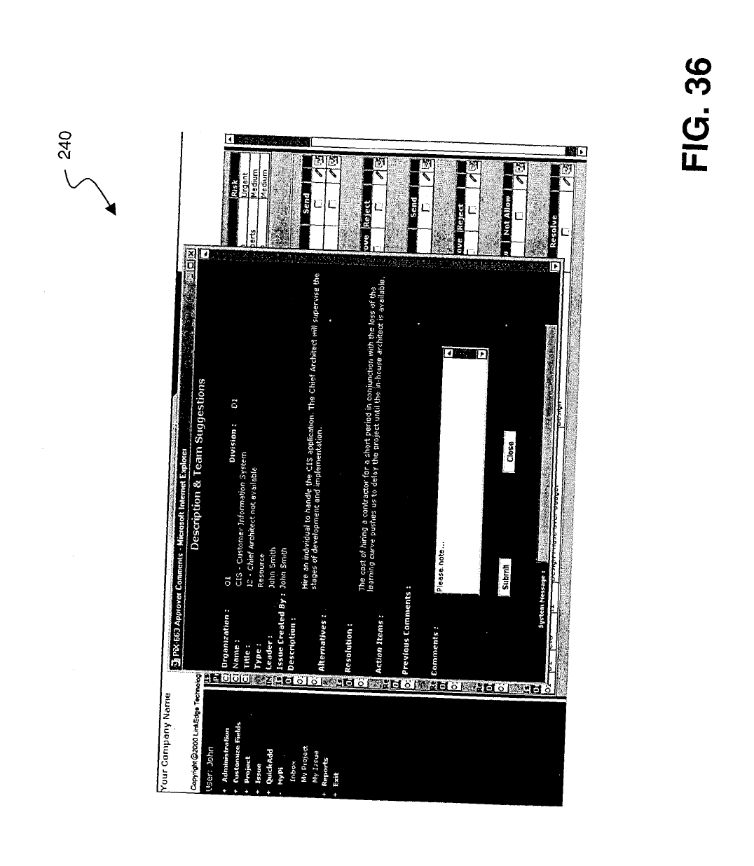

A user's Inbox lists all issues that require some action on her part. This screen lists the Issues to be sent for approval. The box may be checked to send the issue for approval. The screen also lists Issues to be approved, and the “comments” link may be clicked to bring up a comments screen 240 of FIG. 36 to submit comments for the issue. The issues may be approved or rejected, and the comments may be submitted to the Issues to be advised by clicking on the “comments” link. The issues may be removed if the user no longer wants it to appear in her inbox.

The comments on the system for a particular issue is maintained based on a threading concept where all comments are captured, threaded and made accessible to all the authorized users. For example, when an e-mail is sent to all the users on a particular issue (e.g., to all issue team members), different users may send reply e-mails to different subsets of the users. Further, multiple different e-mails may be sent in response to a single e-mail without necessarily making a reference to one another. Therefore, in order to find out all that have been said by the users regarding a particular e-mail, multiple e-mail link searches may be needed. By capturing and storing the comments off the e-mails, a single thread may be maintained and searched to investigate all that have been said on a particular issue, such as in response to a particular e-mail.

A box corresponding to Resolutions to be sent for approval may be checked to send the issue resolution for approval. A pop-up box may appear for the resolution to be entered, and a resolution summary may be mandated to send for approval. A “Comments” link corresponding to Resolutions to be approved may be clicked to submit comments for the issue, which may be approved or rejected. To resolve Issues to be resolved, a resolution summary must be submitted. The user may also opt to change the status of the issue to “resolved.”

The Inbox may be accessed by clicking on the “Inbox” link on the left frame window. Then the “Project” or “Issue” link may be clicked to view project/issue details and to view/submit comments. If the “Edit” icon appears next to the issue, the user may be authorized to modify the issue details. A quick change screen may appear after the user clicks the “Edit” icon, and a “Back” button may be clicked to return to the “Inbox” screen.

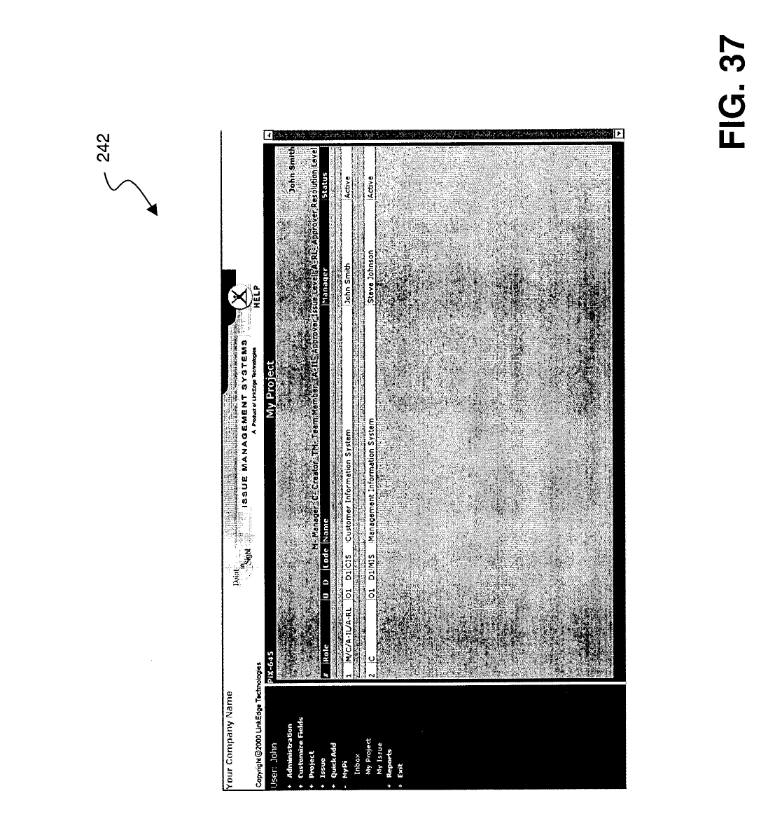

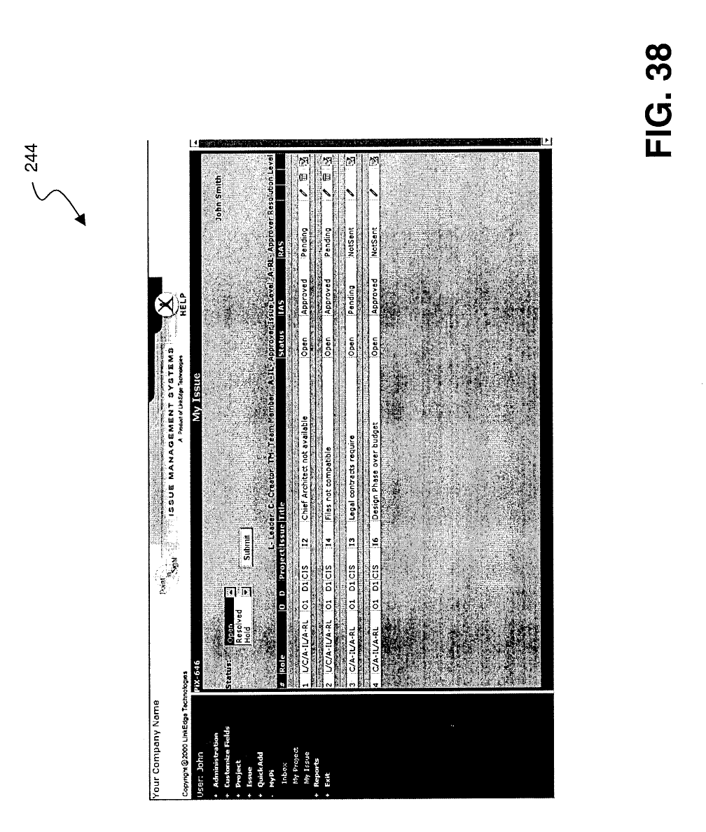

A my project screen 242 of FIG. 37 may list all the projects that a user is involved in. The my project screen 242 may display a user's role, region, group, project name, project code, manager and/or the project status. A my issue screen 244 of FIG. 38 may be used to select the issue status to list the issues that a user is involved in and click “Submit.” The my issue screen 244 may display the user's role, region, group, project code, issue number, issue name, status, issue approval status and/or resolution approval status. If authorized, the user may edit, delete and/or enter comments for these issues.

In an exemplary embodiment according to the present invention, reports are the final result of the data that has been entered into the system. The reports may make it easy for a user to view the data in any manner she chooses. The reports may also allow the user, if authorized, to edit, delete and/or submit comments for an issue directly. In addition, the reports may allow the user to export, print and/or e-mail.

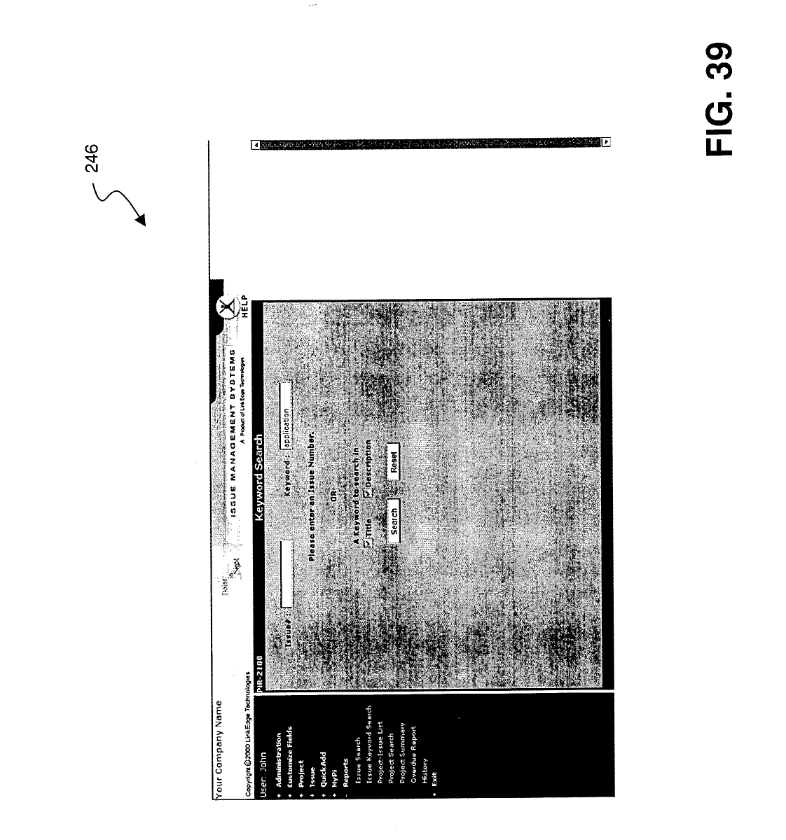

A keyword search screen 246 of FIG. 39 may allow a user to locate issues with a particular word or phrase. If the user has the issue number, she may enter it and locate the issue since the user may enter the issue number or keyword that she would like to search. The keywords may be searched in the Issue Title and/or Description. The “Search” button may be clicked to view the results, and a “Reset” button may be clicked to clear the search criteria.

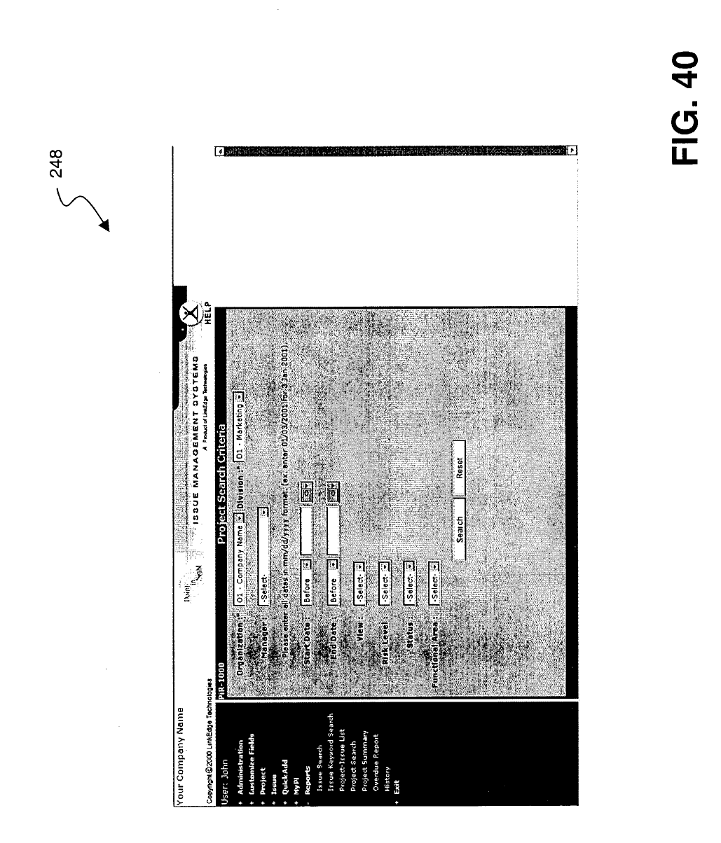

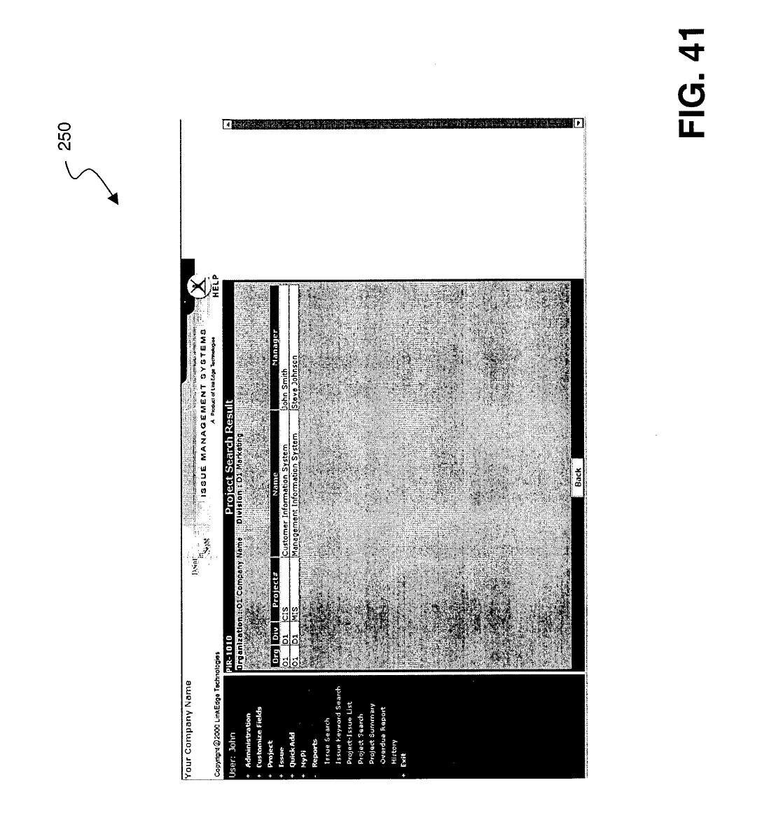

A project search screen 248 of FIG. 40 may list all the projects under the selected organization and/or division. The search criteria may be further narrowed down by the project manager, start and completion dates, view, risk level and project status. The appropriate organization and/or division may be selected from the drop down menu or “All” may be selected to search across all organizations and divisions. For example, the result of the “All” search may be as illustrated on a project search result screen 250 of FIG. 41.

The user may select her specified project search criteria to narrow down the search, and click “Search” to view her report results. The user may view the project details by clicking on the “Project #” link. For example, the private projects may be red and shaded in gray in an exemplary embodiment. A “Reset” button may be clicked to clear the search criteria.

The issue screen may list all the issues under the selected organization and/or division. The search criteria may be further narrowed down and sorted by specific issue details. For example, the appropriate organization and division may be selected from the drop down menu, or “All” may be selected to search across all organizations and divisions. The user may select the project she would like to search under, or she may select “All” to search across all projects.

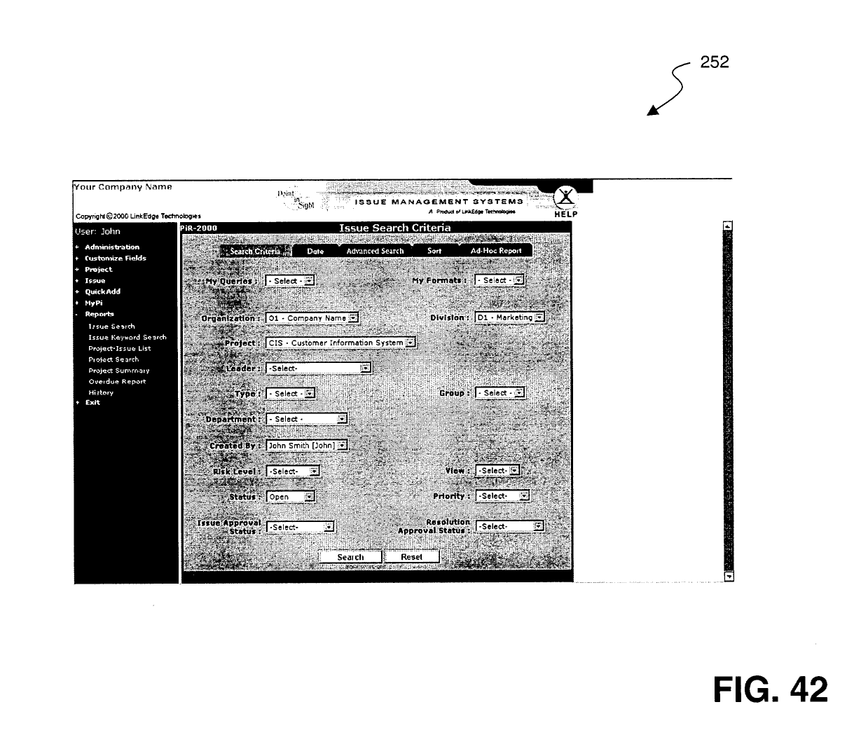

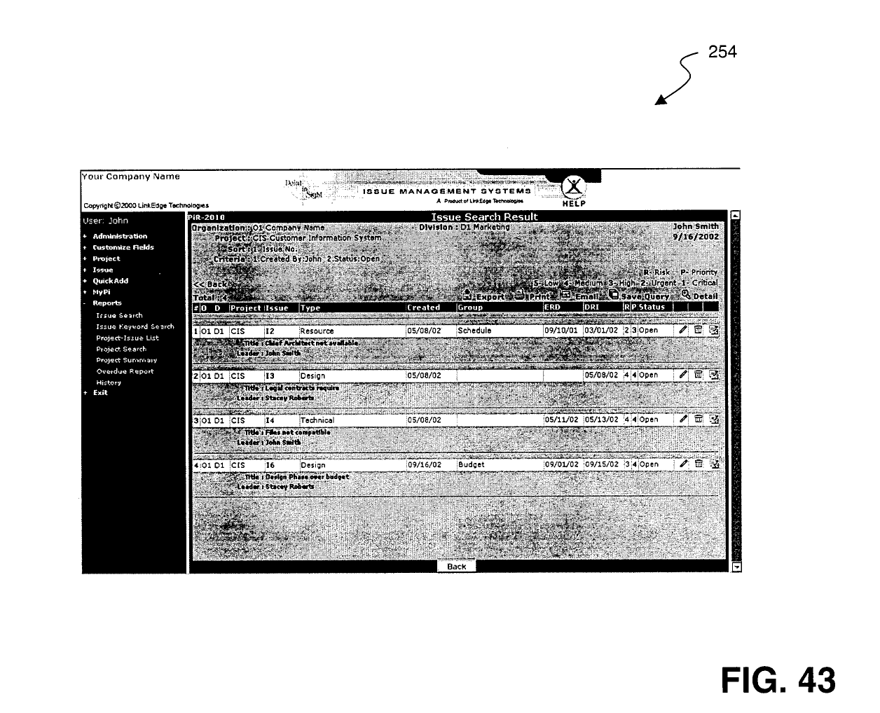

An issue search criteria“screen 252 of FIG. 42, for example, may give the user an option to search issues under any particular project based on the issue team leader, type, group, created by, risk level, issue status, view, priority, approval status, and/or resolution approval status. The result of “All” search criteria search, for example, may be as illustrated on issue search result screen 254 of FIG. 43.

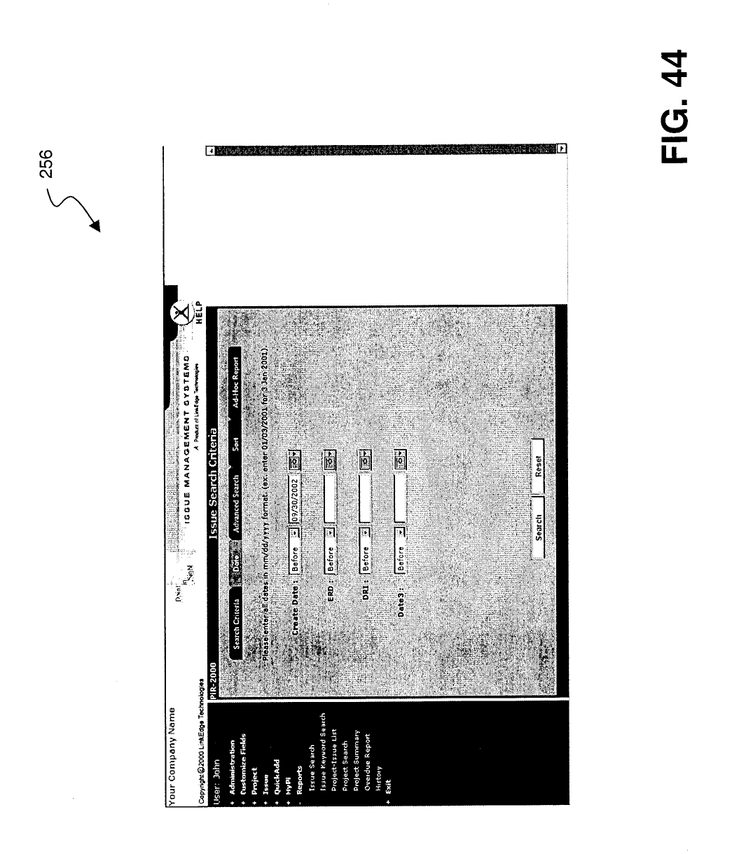

By clicking the “Date” tab link, the user may search within a specified time period for the Issue create date, Expected resolution date, Date when risk increases and/or other applicable dates as illustrated on a date search screen 256 of FIG. 44.

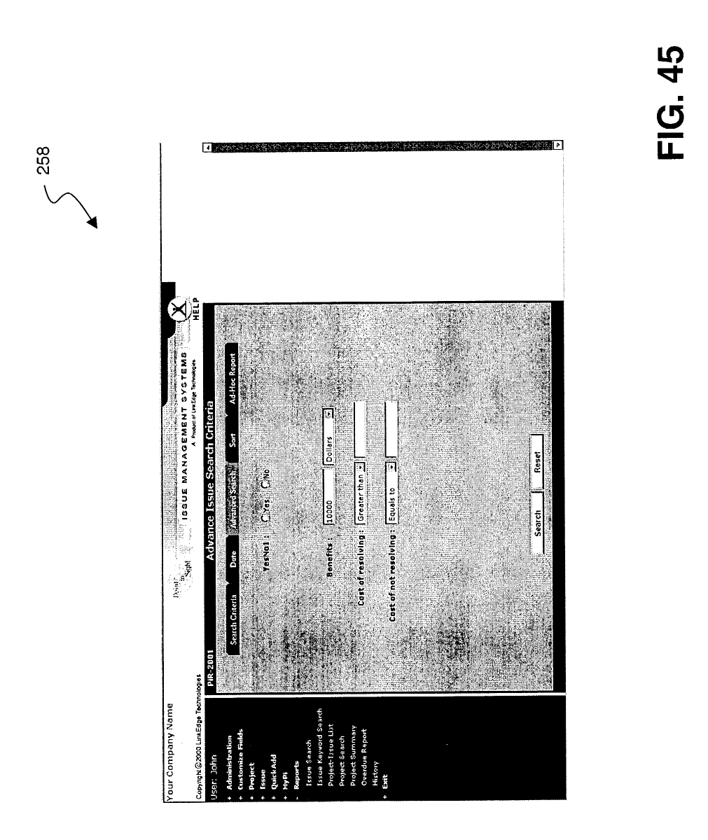

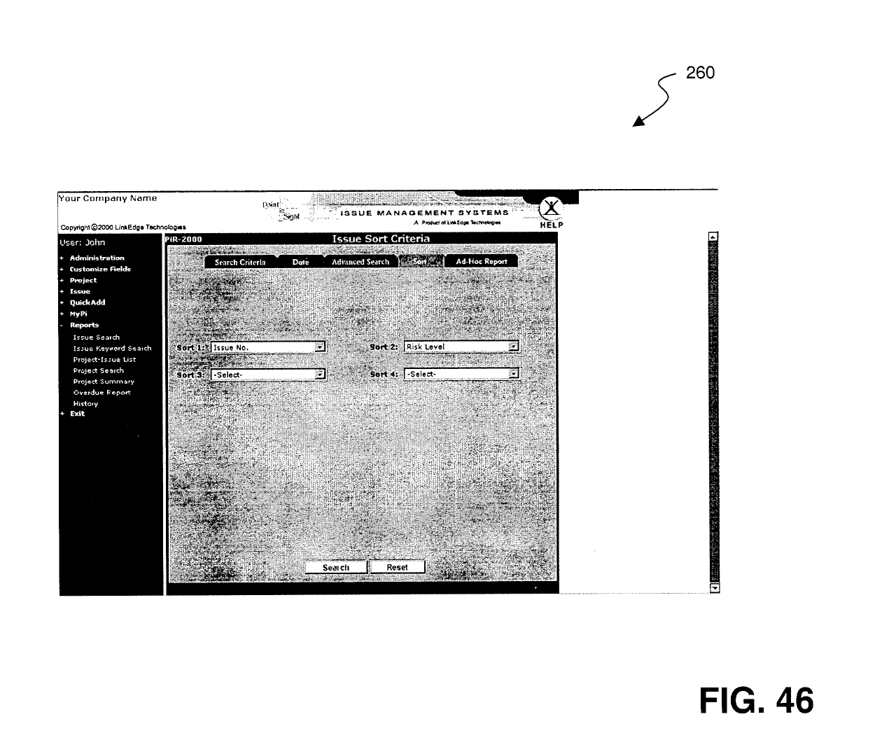

By clicking an “Advanced Search” tab link, the user may search issues under any particular project based on additional fields as illustrated on an advanced issue search criteria screen 258 of FIG. 45. By clicking “Sort” tab link, the user may order by four sort categories, in which the user may select the sort criteria by selecting it from the drop down menu on issue sort criteria screen 260 of FIG. 46. By default, Sort1 is by Issue Number in the exemplary embodiment.

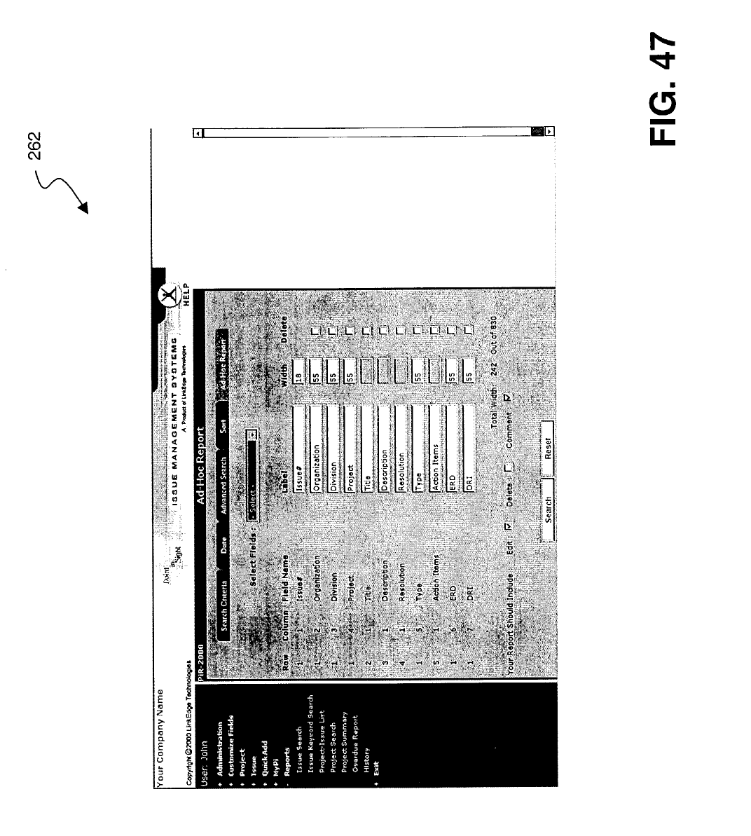

By clicking an “Ad-Hoc Report” tab link, the user may customize the fields, labels and/or column size for the report as illustrated on ad-hoc search criteria screen 262 of FIG. 47. The user may select the fields from the drop down menu, and/or enter the width for the labels selected. In other embodiments, the label may have a preset width length. The user may choose to have the “Edit, ” “Delete, ” and/or “Comments” links appear on the report.

The user may click “Search” to view the report results. The user may also click on the “Issue #” link to view the issue details, and click on the “Edit” link to modify the issue details. The “Edit” link may not appear if the particular user is not authorized to make changes. Further, the user may click “Modify” link to save the changes she made to the issue details. In addition, the user may click “Back” link to return to the Issue Search Result report screen. In addition, the user may click on the “Reopen” link to reopen rejected and resolved issues. The “Reopen” link may not appear if the user is not authorized to make changes.

The user may click the “Save Query” or “Save Format” button in the top left hand corner to save the query or Ad Hoc Format. The user may also view a previous query or format created by selecting it from the drop down menu of “My Queries,” and “My Formats” under the “Search Criteria” link. Further, the user may click the “Detail/Summary link” at the top right corner of the screen to change the view of the report to summary or detail. In addition, the user may click “Reset” to clear her search criteria. The summary report may include the issue title and resolution summary. The detailed report may include the issue title, resolution summary, issue description, alternatives, resolution summary, action items and/or comments.

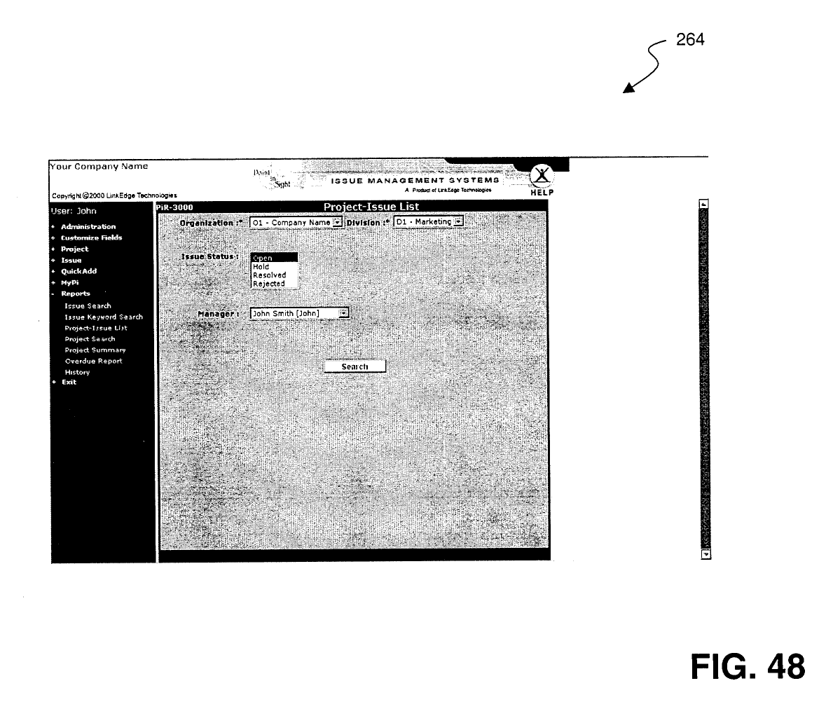

A project-issue list as illustrated on a project-issue list screen 264 of FIG. 48 is a simple listing of all issues for a project and sub-projects, selected by issue status. If sub-projects have been created, then they may be shown here in a “tree” format. The user may choose the appropriate organization and/or division or select “All” to search across all organizations and divisions. The user may also select an issue status from the menu, and may select a project manager to search for projects under that manager.

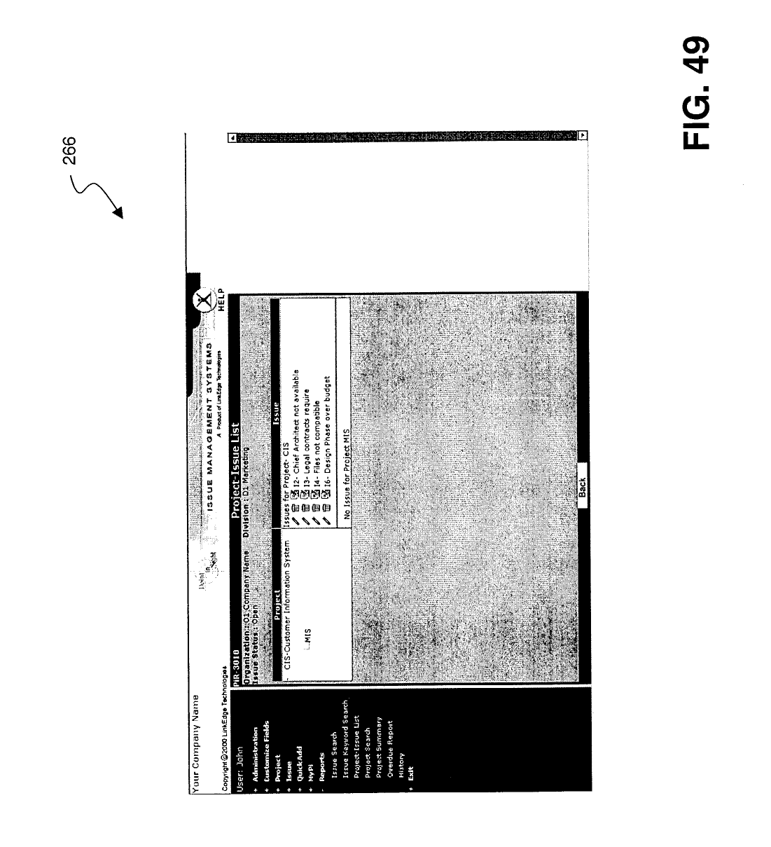

The user may also: 1) click “Search” to view her report results; 2) click on the project name link in the “Projects” column to view the project details; 3) click on the link next to the project name to view the issue list under that project; 4) click on the issue name link in the “Issues” column to view the issue details; 5) click on the “Edit” link to modify the issue details (if the “Edit” link does not appear, the user may not be authorized to make changes); 6) click “Modify” link to save the changes you have made to the issue details; 7) click “Back” to return to the Project-Issue List report screen; and/or 8) click on the “Delete” link to delete the issue (if the “Delete” link does not appear, the user may not be authorized to delete the issue or comments have been made) The private projects and issues may be highlighted in red. To view or hide sub-projects and issues, the user may click on the red “+” and “−” buttons next to the project name. The results of the search criteria may be as illustrated on a project-issue list screen 266 of FIG. 49.

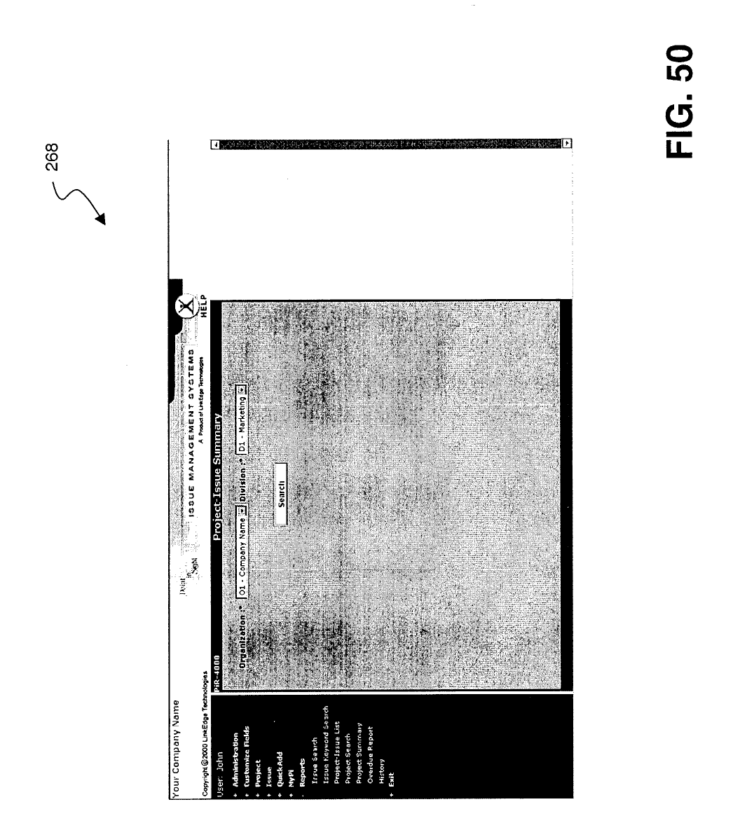

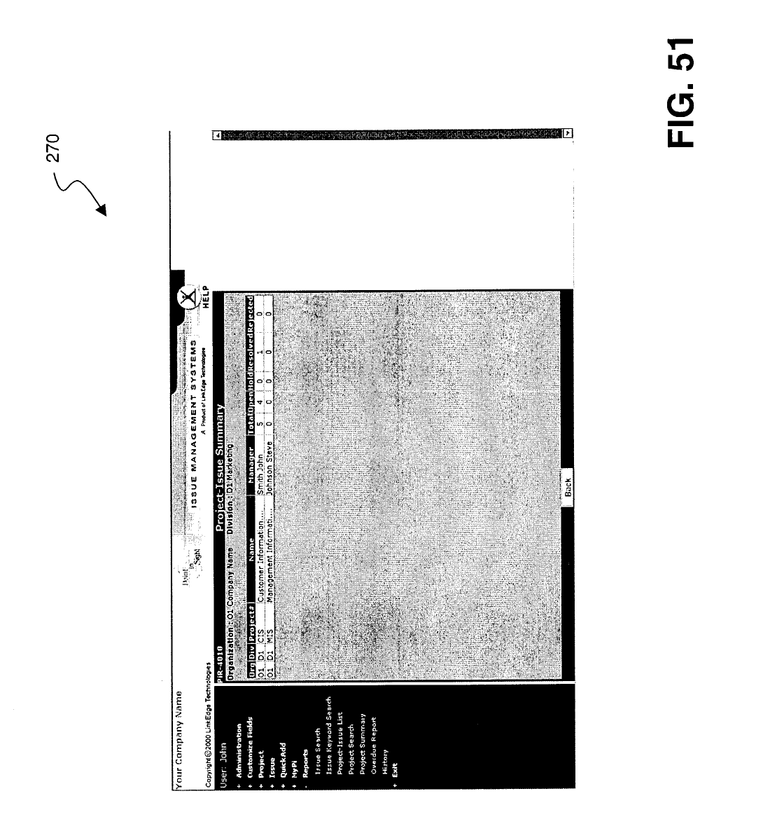

A project-issue summary screen 268 of FIG. 50 may list all the projects under the selected organization and/or division. This may provide the user with an overview of the projects and the status of their issues. The user may choose the appropriate organization and division or select “All” to search across all organizations and divisions. Further, the user may click “Search” to view her report results. By clicking on the project name link in the “Projects” column, the user may view the project details. The private projects, for example, may be indicated in red and shaded in gray. A project-issue summary screen 270 of FIG. 51 illustrates results of search “All” criteria in an exemplary embodiment

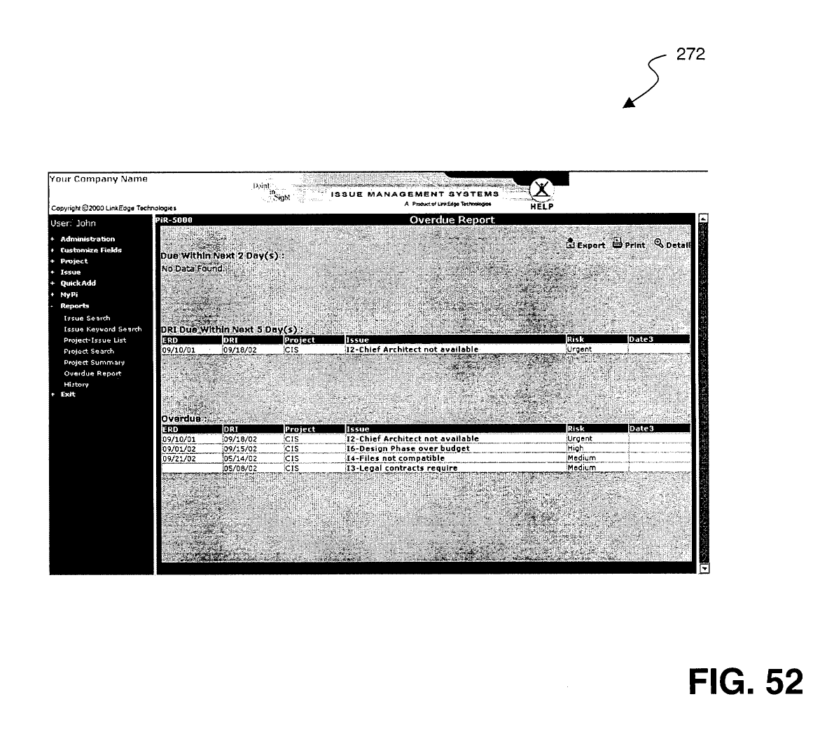

An overdue report screen 272 of FIG. 52 may provide a user with a summary of issues that are due in the next period as defined by the administrator. This report uses the Expected Resolution Date (“ERD”) and Date when Risk Increases (“DRI”) to generate the ‘what is coming due’ scenario. The summary due report may list all the Issues that are overdue within the user's specified due date. The user may click on the Project and Issue link to view the Project and Issue Details. The Summary Due Report may generate one line per issue to highlight the items coming due.

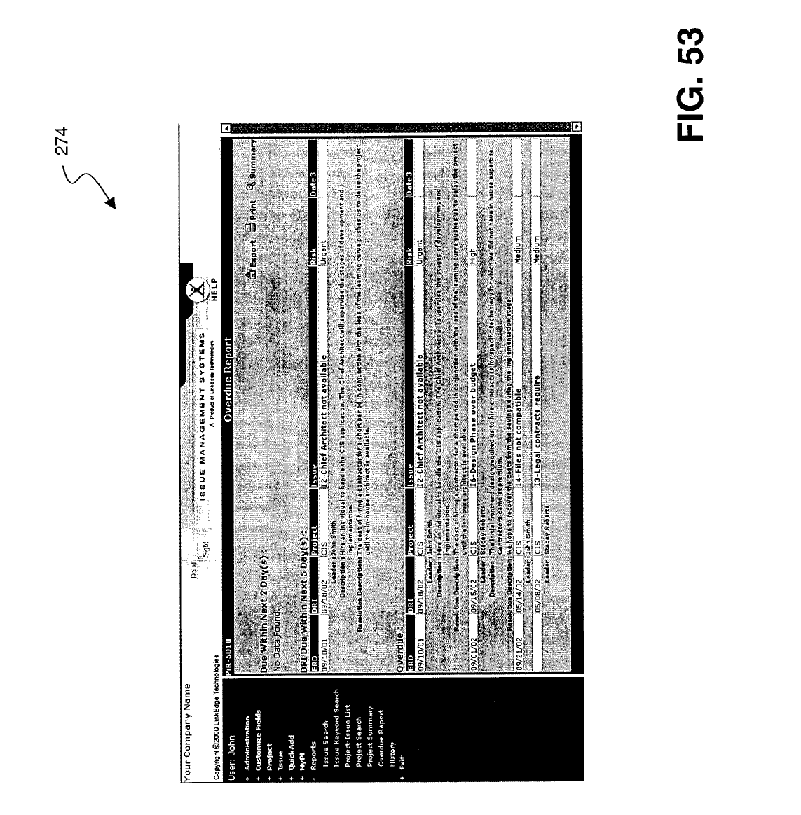

A detail due report screen 274 of FIG. 53 may provide the user with the detail of issues that are due in the next period as defined by the administrator. This report uses the Expected Resolution Date (“ERD”) and Date when Risk Increases (“DRI”) to generate the ‘what is coming due’ scenario. The user may click on the Project and Issue link to view the Project and Issue Details.

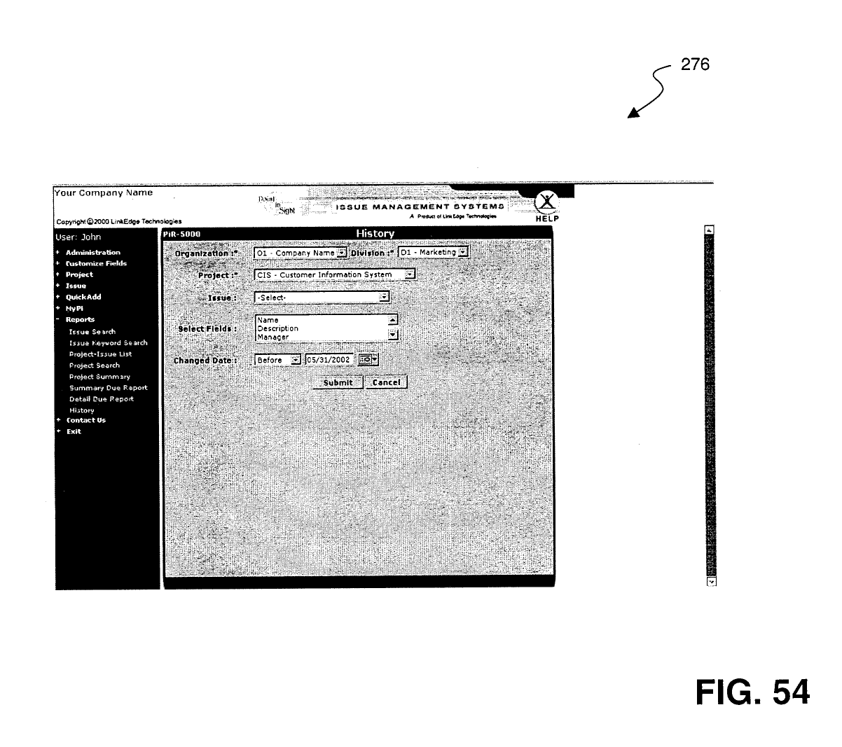

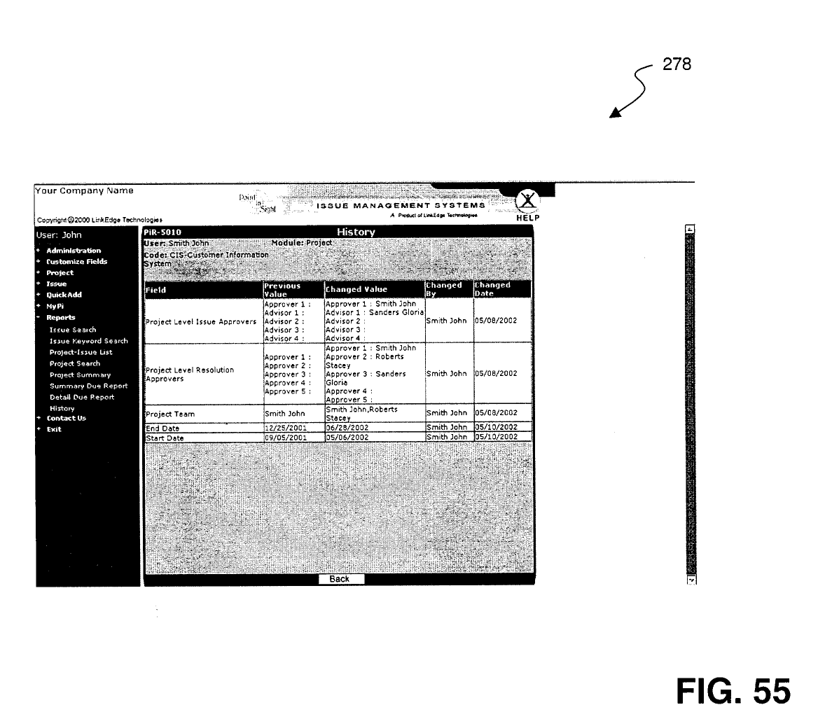

Almost every transaction executed may be documented automatically by the system. The issue management system of the present invention may record the type of change, who made the change and the date and time. The user may view the history of changes made to projects and issues by using the history icon in the bottom right corner of each screen or via history reports. The user may also click on “History” link on the left window frame to bring up a history screen 276 of FIG. 54. In addition, the user may select the Organization, Division and Project the user would like to view the history of. Further, the user may select the criteria, specific fields she would like to search. The user then may enter the “Changed Date” button and click “Submit” button. A history report 278, for example, is illustrated on FIG. 55.

In an exemplary embodiment according to the present invention, users may select issues for archiving onto a disk or on a separate database. This information may then be retrieved upon request. An issue may have several status during its development cycle. When an issue is added, it is in “Open” status. This is an active issue that is being worked on by the issue team. If there is a break in the issue processing, the issue team may change the status to “hold”. When the issue resolution is documented to the satisfaction of the issue team, the issue status may be changed to “resolved”. Before changing the status to “resolved”, the system may ask the user to fill in the “resolution summary”. The user may add a resolved issue into the system at anytime.

The issue status may be changed at the time of adding an issue in the “Quick Add” or the “Create New” functions. It may also be modified later using the “Issue Details” functions on the left window frame. Table 1 below illustrates different issue status options that may be available in the exemplary embodiment.

TABLE 1
Issue Status Options

| | When does it | Who can | |
|---|---|---|---|
| Status | become? | change? | Conditions |
| Open | Upon adding | Issue Creator | |
| | the issue | or Leader | |
| Hold | Any time in | The Issue | Removed from the |
| | the process | Team | Process |
| Resolved | Approver | The Issue | Must add resolution |
| | resolves | Team | summary. Resolution |
| | | | Approval Status = |
| | | | Approved |
| Rejected | Approver | | |
| | rejects | | |
| Reopen | Resolved or | Issue Creator | |
| | rejected issue | or Leader | |

A project may have a status of Active, Inactive, or Deleted, and the project manager or project creator may change the status of the project. An issue may have two approval statuses in an exemplary embodiment according to the present invention. One approval status is the Issue Description Approval Status and the second is the Issue Resolution Approval Status.

The Issue Description Approval Status may reflect the status of the approval process for the problem statement of the issue. When an approver is assigned, the approval status may be designated to be “Not Sent.” When issue team sends this issue description for approval, the issue status may change to “Pending”. The status may remain “Pending” until the approver approves or rejects the issue description. If approved, the status of the issue description approval may become “Approved”. If the approver chooses to reject the issue description, the status of the issue description may become “Rejected”. If no approver but advisors are selected, then this status will be set to “Only Advisor”. If no approver and advisors are selected, then this status may be set to “None Selected”.

Once the Issue Description has been approved, the description may no longer be modified. If modification is required, an override may be executed by the Project Manager. Once the Project Manager has authorized the override, the team may modify the description. Table 2 shows issue description approval status options that may be available in an exemplary embodiment according to the present invention.

TABLE 2
Issue Description Approval Status Options

| | | Who can | |
|---|---|---|---|
| Status | When does it become? | change? | Conditions |
| None | No Approvers and | | |
| Selected | Advisors are selected. | | |
| Not Sent | If the Issue Team is | | |
| | still working on it. | | |
| Only | If only Advisors are | No Approver | |
| Advisor | selected | | |
| Pending | Upon adding the | Automatic | Approver added |
| | Approver | | |
| Approved | When the description | Automatic | Approver |
| | is Approved. | | approves |
| Rejected | When the description | Automatic | Approver |
| | is Rejected | | rejects |

The Issue Resolution Approval Status may reflect the status of the solution statement of the issue (issue resolution). When one or more approvers are assigned to the issue resolution process, this status may be set to “Not Sent”. If the issue team sends the issue resolution for approval, then this status may be set to “Pending”. The status may remain “Pending” until all the selected approvers have approved the issue resolution. If all of the Approvers have sent in their approvals, the issue resolution approval status may be automatically changed to “Approved”. If even one of these Approvers rejects the issue resolution, the issue resolution approval status may be set to “Rejected”. If no Approver selected then its status set to “None Selected.”

Once the Issue Resolution has been Approved, it may no longer be modified. If modification is required, an override may be executed by the Project Manager. Once the Project Manager has authorized the override, the team may modify the resolution. Table 3 illustrates issue resolution approval status options that may be available in an exemplary embodiment according to the present invention.

TABLE 3
Issue Resolution Approval Status Options

| | | Who can | |
|---|---|---|---|
| Status | When does it become? | change? | Conditions |
| None | No Approvers are | | |
| Selected | selected. | | |
| Not Sent | If the Issue Team is | | |
| | still working on it. | | |
| Pending | Upon adding the | Automatic | Approver(s) |
| | Approver(s) | | added |
| Approved | When the Resolution is | Automatic | All mandatory |
| | Approved by all | | Approvers |
| | selected Approvers. | | Approve |
| Rejected | When the Resolution is | Automatic | At least one |
| | Rejected by even one | | mandatory |
| | mandatory Approver. | | Approver Rejects |

The following should be noted-for an exemplary embodiment according to the present invention: 1) Once the issue is resolved or rejected the issue may be reopened by the Issue Creator or Leader; 2) If the issue status is on hold, the issue will be removed from the approval process; 3) The date of each activity is to be recorded; 4) Issue may not be approved until approver's mandatory/non-mandatory approves it.

The approval process in an exemplary embodiment according to the present invention is easy and comprehensive yet flexible at the same time. The rules based structure in the exemplary embodiment is outlined here.

1) Approvers for the description of the issue and for the description of the resolution may be different. The user may choose to send one for approval and not the other.

2) All approvers may be first chosen at the project level. That is to say that the project manager may limit who the issue creators may send their issues to for approvals. However, the system may allow the manager to also decide whether to allow the issue creator to add approvers that have not been pre-determined.

3) The project manager may decide that there will be no approvers for this project. In this case, no approver screens may be provided during the creation of an issue.

4) The approvers may be selected as mandatory or optional approvers at the project level. Mandatory approvers should be chosen by the issue team, but optional approvers may be selected from outside the issue team. This may allow for a case-by-case determination of the approval team.

5) If the project manager chooses not to “Allow Users to Choose Approvers at Issue Level”, then the selection of the approvers at the issue level may be limited to the approvers that were chosen at the project level.

6) If the project manager chooses to “Allow Users to Choose Approvers at Issue Level”, then the issue team may add an approver that was not created at the project level.

7) If the approvers are chosen as mandatory by the project manager, they may not be de-selected at the issue level.

8) If the approvers are chosen as optional by the project manager, they may be de-selected at the issue level. Once selected, however, mandatory and optional approvers may go through the same process.

9) E-mails may be sent to the approvers to inform them that they have been selected.

10) Issues may go to the Inbox of the approvers only when the issue team decides to do so. The button to send for approvers may be found on the Approvers screens of the issue and the Quick Add screens.

11) Once an issue is approved, it may not be modified. The description of that issue, or its resolution may not be modified, unless the Project Manager has granted Override authority.

Once the approvers have been added to a project or an issue, they may be changed or deleted as the need arises. Here is the process that is used for this in an exemplary embodiment according to the present invention. Project Level Issue approvers or Project Resolution approvers may be modified after the project has been added. An approver may be removed from the list. When removed, no further issues may show her as mandatory or optional approver. An approver may be added to the list. All new issues created for this project may show this new addition upon creation.

Issue Level approvers or Issue Resolution approvers may be modified after an issue has been added to a project. An approver may only be removed if she was not selected as mandatory by the project manager. If the approver was mandatory, the project manager has indicated that she must be chosen as an approver and therefore may not be removed. Approvers may also be added to the issue after issue creation. The approvers that the issue leader or creator may choose from will be those that the project manager has limited the project to.

The ability to create an organization hierarchy within an exemplary embodiment according to the present invention may allow the user to replicate their organizational structure within the system of the exemplary embodiment organizations are the highest level in the hierarchy. There may be more than one organization. Divisions are the second highest level in the hierarchy and they belong to organizations. There may be more than one division for each organization. Projects are the third level of hierarchy. Projects belong to an organization and division combination. There may be many projects for one division. A relationship between projects may be established as in programs to projects. That is to say that there may be many sub-projects for a project and many sub-sub-projects for a sub-project. In order to create project/sub-project tree, all projects should be created first. After that, the relationship between projects may be established using the sub-project screen.

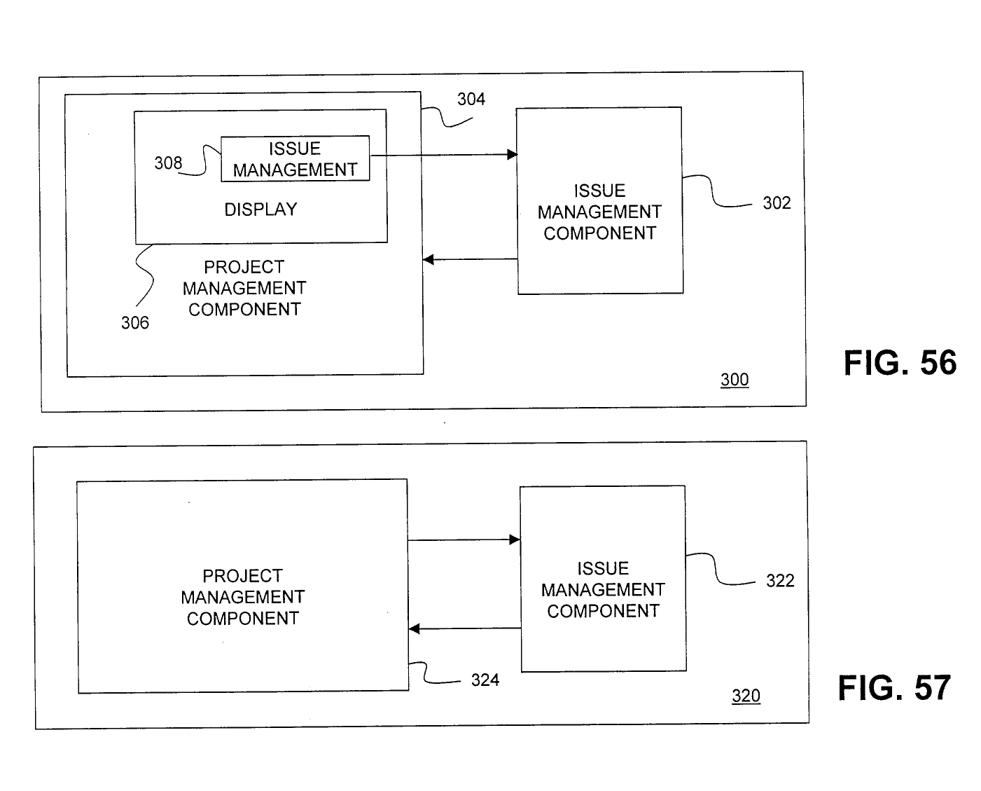

FIG. 56 is a block diagram of a project management system 300 that includes an issue management component 302 and a project management component 304 in an exemplary embodiment according to the present invention. The issue management component 302 may, for example, be substantially the same as the issue management system disclosed in detail herein, such as the system illustrated on FIG. 1. Hence, the issue management component 302 is not strictly limited to issue management, but may also incorporate some project management functions. The project management component 304 may be any suitable project planning/management/scheduling software application, such as MICROSOFT® OUTLOOK®. MICROSOFT® and OUTLOOK® are registered trademarks of Microsoft Corporation, a Washington corporation, Redmond, Wash.

In this exemplary embodiment, an issue management button 308 is added on a display 306 of the project management component. For example, a user may press the issue management button 308 to invoke the issue management component 302. The action items, issues, projects or the like, and due dates thereof, of the issue management component 302 may be displayed, for example, on the list of tasks (e.g., Task List) or today's schedule (e.g., Outlook Today) of the display 306.

FIG. 57 is a block diagram of a project management system 320 that includes an issue management component 322 and a project management component 324 in another exemplary embodiment according to the present invention. The issue management component 302 may, for example, be substantially the same as the issue management component 302 of FIG. 56. As such, the issue management component 322 is not strictly limited to issue management, but may also incorporate some project management functions. The project management component 324 may be any suitable project planning/management/scheduling software application, such as, for example, MICROSOFT® PROJECT and PRIMAVERA®. PRIMAVERA® is a registered trademark of Primavera Technologies, Inc., a Delaware corporation, Wilmington, Del.

For example, project plans may be developed using the project management component 324. These project plans may then be loaded into the issue management component 322 so that issues may be assigned to each project or task. When the issues have been resolved or completed, the issue management component 322 can flag the project management component 324 of such resolution or completion. The issue management component 322 may also provide a report and/or other data to the project management component 324 to inform it of how the issues have been resolved.

It will be appreciated by those of ordinary skill in the art that the invention can be embodied in other specific forms without departing from the spirit or essential character hereof. For example, those skilled in the art would appreciate that various different macros and functions described above may have different names in other embodiments, and may be defined with different parameters. The present description is therefore considered in all respects to be illustrative and not restrictive. The scope of the invention is indicated by the appended claims, and all changes that come within the meaning and range of equivalents thereof are intended to be embraced therein.

I claim:

1. An issue management system for tracking and resolving issues across an organization, the system comprising:
a database suitable for storing a plurality of issues, each issue pertaining to a project and to be resolved by an issue team having at least one member;
a database updater capable of dynamically updating the database in response to a first e-mail sent by said at least one member of the issue team; and
an e-mail sender capable of automatically sending a second e-mail to said at least one member of the issue team,
wherein the issues and their resolutions are automatically stored in the database, and
wherein the issues can be consolidated at an enterprise level across the organization.

2. The issue management system of claim 1, wherein the e-mails are used for at least one of alert and notification.

3. The issue management system of claim 1, wherein the system supports a hierarchy in which the project can be divided into sub-projects, and the issues can be correlated with relevant sub-projects.

4. The issue management system of claim 3, wherein each of the sub-projects can be further divided into sub-projects, wherein said issues can be correlated with relevant sub-projects at any point in the hierarchy.

5. The issue management system of claim 3, wherein on-line reports regarding the issues can be provided to managers anywhere in the hierarchy, thereby allowing for efficient streamlining of issue resolution.

6. The issue management system of claim 1,
wherein the system can require at least one approval for a particular issue before it is available for public viewing,
wherein a manager can decide to require approvals for documented resolution before the issue can be considered resolved, and
wherein approvals can either be required for all issues of the project, or be required depending on the issue on an issue-by-issue basis.

7. The issue management system of claim 1, wherein the system allows the issue team to choose not to require an approval for resolution of a particular issue.

8. The issue management system of claim 1, wherein an issue leader can solicit advice from other members of the organization, wherein the issue leader is not looking for approval, but is seeking a point of view from the other members.

9. The issue management system of claim 1,
wherein a user can search for similar issues across projects and the entire organization by using at least one of issue classifications and key word searches, and
wherein visibility can specifically be provided to those issues that are similar, and are being addressed by various groups within the organization.

10. The issue management system of claim 9, wherein the key word searches are user-defined.

11. The issue management system of claim 9,
wherein all common issues relating to a particular subject for resolution at the enterprise level is provided for via enterprise level reporting, and
wherein all issues pertaining to a particular element can be printed on a single report.

12. The issue management system of claim 1, wherein a project manager can decide whether the issues documented for the project are to be available for public viewing,
whereby executive management is provided with an ability to be discreet, while at the same time allowing them the use of an enterprise level tool that can clearly and exhaustively document any of their project issues.

13. The issue management system of claim 1, further comprising various levels of security built-in to its processing,
wherein project managers and issue leaders can authorize users or teams to be able to modify the issues,
whereby these authorized users or teams have the ability to add, maintain and delete project and issue information.

14. The issue management system of claim 1, wherein a user is allowed to create a library,

15. The issue management system of claim 1, wherein documents can be attached to the project or the issues for reference by the issue team.

16. The issue management system of claim 1,
wherein the system works on a concept of project teams and issue teams, wherein teams can be in multiple locations, even internationally,
wherein team security can be applied over multiple locations,
whereby a user can have control of issues over projects across the organization, across the nation, and across international borders.

17. The issue management system of claim 1, wherein a user has an ability to create reports with a column heading of her choice, whereby users can create their own report format.

18. The issue management system of claim 1, wherein users can quantify the impact of an issue in financial terms, and wherein the users can perform searches based on cost.

19. The issue management system of claim 1, further comprising a bird's eye view of an organization,
wherein users can view a number of issues created, resolved, due and overdue in the project or across the organization at a glance,
whereby the users can select top projects or issues that they want to keep in touch with.

20. The issue management system of claim 1, wherein users can assign tasks to members of the issue team, wherein the tasks are to be completed in order to resolve the issue,
wherein the tasks show up in an inbox of a member they are assigned to through the use of e-mail.

21. The issue management system of claim 20, wherein the tasks further show up in a dashboard of the member, wherein the dashboard is an applications inbox.

22. The issue management system of claim 1,
wherein e-mails can be sent out automatically with pertinent issue information to anyone that has an e-mail address.

23. The issue management system of claim 1, wherein users can customize their own screens, and the users can select which fields they want to see for each issue or project screen,
wherein the users can determine whether they want the fields to be mandatory or optional.

24. The issue management system of claim 1, wherein queries are allowed by various elements of the issues, including the generation of status reports.

25. The issue management system of claim 1, wherein the database is capable of retaining a history of who made changes to the database as well as a date and time of such changes.

26. The issue management system of claim 1, wherein the e-mail sender sends an alert or notification to the issue as triggered by a predetermined due date.

27. The issue management system of claim 1, wherein the issues are tracked and resolved in a standardized manner.

28. A method of managing issues across an organization, said method comprising:
creating an issue to be resolved by an issue team having at least one member, said issue pertaining to a project;
sending an e-mail containing the issue to the database, wherein the database is automatically updated to store the issue;
automatically sending an e-mail to said at least one member of the issue team to notify or alert said at least one member;
resolving the issue; and
sending an e-mail containing a resolution of the issue to the database, wherein the database is automatically updated to store the resolution,
wherein the issue can be consolidated with other issues at an enterprise level across the organization.

29. The method of claim 28, further comprising submitting the resolution to an approver for approval.

30. The method of claim 29, wherein the approver sends a comment on the resolution to the issue team along with approval or rejection of the resolution.

31. The method of claim 28, further comprising submitting the resolution to an advisor, wherein the advisor sends a comment on the resolution to the issue team.

32. The method of claim 28, further comprising exporting at least one of a report and data from the database.

33. The method of claim 28, further comprising sending an e-mail alert or notification to the issue team on a predetermined trigger date.

34. The method of claim 28, wherein the issues are managed in a standardized manner.

35. A project management system comprising:
an issue management component for tracking and resolving issues in a standardized manner across an organization, the issue management component comprising:
a database suitable for storing a plurality of issues, each issue pertaining to a project and to be resolved by an issue team having at least one member;
a database updater capable of dynamically updating the database in response to a first e-mail sent by said at least one member of the issue team; and
an e-mail sender capable of automatically sending a second e-mail to said at least one member of the issue team,
wherein the issues and their resolutions are automatically stored in the database, and
wherein the issues can be consolidated at an enterprise level across the organization; and
a project management component that has been integrated with the issue management component.

36. The project management system of claim 35, wherein the project management component comprises a display for user interface, said display comprising an issue management button that can be pressed to invoke the issue management component.

37. The project management system of claim 35, wherein the project management component is used to develop project plans, wherein the project plans are loaded into the issue management component so that issues can be assigned to each project or task, and wherein the issue management component flags the project management component upon resolution of the issues.

38. The project management system of claim 37, wherein the issue management component provides a report to the project management component to inform it of how the issues have been resolved.
